(19) United States
(12) Patent Application Publication
(10) Pub. No.: US 2017/0059411 A1
(43) Pub. Date: Mar. 2, 2017

(54) FTIR System and Method for Compositional Analysis of Matter

(71) Applicant: Thermal-Lube, Inc., Pointe-Claire (CA)

(72) Inventors: David Pinchuk, Montreal West (CA); Frederik R. van de Voort, Dollard des Ormeaux (CA)

(73) Assignee: THERMAL-LUBE, INC., Pointe-Claire (CA)

(21) Appl. No.: 14/835,814

(22) Filed: Aug. 26, 2015

(51) Int. Cl. G01J 3/45; G01N 21/3577; G01N 21/3563; G01J 3/10

(52) U.S. Cl. CPC G01J 3/45; G01J 3/108; G01N 21/3577; G01N 21/3563; G01N 2021/3595

(57) ABSTRACT

The present application is directed to a system and method for analysis of a predefined component (e.g., moisture, acid, or carbonate base content) of matter using a reagent that reacts with the predefined component to produce carbon dioxide gas. FTIR analyses are performed on contents of sealed vessels that hold a number of standard mixtures which include the reagent and a component part similar to the predefined component at different concentrations of the component part in order to derive a calibration equation that relates concentration of the predefined component to absorbance in a predefined spectral band characteristic of carbon dioxide gas concentration. FTIR analysis is performed on the contents of a sealed vessel that holds a mixture derived from a sample and the reagent. Data that characterizes concentration of the predefined component in the sample is calculated based on the absorbance in the predefined spectral band and the calibration equation.

### BACKGROUND

1. Field

The present disclosure relates broadly to a system and method for compositional analysis of matter. More particularly, the present disclosure relates to systems and methods for analysis of moisture, acidity and/or basicity of matter (particularly hydrophobic fluids, such as lubricants, edible oils, transformer oils and fuels including biodiesel, but also applicable to the extracts thereof and those of foodstuffs, pharmaceuticals and other suitable solid matrices) using infrared spectroscopy, in particular with Fourier Transform Infrared (FTIR) spectroscopy.

2. State of the Art

Infrared (IR) spectroscopy is the subset of spectroscopy that deals with the infrared region (e.g., typically including wavelengths from 0.78 to approximately 300 microns) of the electromagnetic spectrum. It covers a range of techniques, the most common being a form of absorption spectroscopy. As with all spectroscopic techniques, it can be used to identify compounds or investigate sample composition. A common laboratory instrument that uses this technique is an infrared spectrophotometer. Infrared spectroscopy exploits the fact that molecules have discrete rotational and vibrational energy levels and absorb infrared light at specific frequencies that are determined by the differences in energy between these discrete energy levels.

In IR absorption spectroscopy, the infrared spectrum of a sample is recorded by passing a beam of infrared light through the sample or placing the sample on the surface of an internal reflection element through which a beam of infrared light is passed by total internal reflection. Measurement of the transmitted or totally internally reflected light striking a detector reveals how much energy was absorbed at each wavelength. This can be done with a monochromatic beam, which changes in wavelength over time. Alternatively, a polychromatic IR beam (e.g., a range of IR wavelengths) can be passed through the sample to measure a range of wavelengths at once. From this, a transmittance or absorbance spectrum (referred to herein as a “spectrum”) is produced, showing the IR wavelengths at which the sample absorbs. Analysis of the absorption spectrum for the sample reveals details about the molecular structure of the sample.

Fourier Transform Infrared (FTIR) spectroscopy is a form of IR absorption spectroscopy that utilizes an interferometer placed between a polychromatic source of IR light and the sample. Measurement of the light striking the detector produces an interferogram. Performing a Fourier transform on the interferogram shows the IR wavelengths at which the sample absorbs. The development of FTIR technology has substantially enhanced the utility and sensitivity of IR spectroscopy as a tool for quantitative analysis. In addition, various data analysis techniques have been developed to facilitate accurate quantitative analysis of highly complex sample mixtures subjected to IR spectroscopic examination. The information inherent in the absorption spectrum of such sample mixtures includes information at the molecular level about the chemical composition of the mixture. Thus, FTIR technology and analysis allows for the determination of the concentrations of the components in the sample mixture, and for the detection of contaminants or other unwanted chemical components or compounds in the sample mixture.

One area in which FTIR spectroscopy has been extensively utilized is in the monitoring of the condition of lubricating fluids, an activity which has commonly been performed in commercial laboratories. For example, FTIR spectroscopy has been employed to monitor the levels of additives present in such fluids and of degradation products that may be generated as a result of breakdown of the fluid. In another example described by Jun Dong, Frederick R. van de Voort, Varoujan Yaylayan and Ashraf A. Ismail in “Determination of Total Base Number (TBN) in Lubricating Oils by Mid-TFIR Spectroscopy,” Society of Tribologists and Lubrication Engineers, March 2009, the total base number (TBN) of a lubricating oil sample is quantified by an FTIR method that employs calibration standards with TBN values of 0-20 mg KOH/g prepared by adding barium dinonylnaphthalene sulfonate (BaDNS) concentrate to an additive-free polyalphaolefin (PAO) base oil. The calibration standards are subject to FTIR spectrum scanning. The absorbance at 1672 cm⁻¹ relative to the absorbance at 2110 cm⁻¹ for each calibration standard is fit to calculated TBN values to derive a calibration equation that relates absorbance at 1672 cm⁻¹ relative to the absorbance at 2110 cm⁻¹ to a TBN value. The lubricating oil sample is split into two parts. One of the two sample parts is subject to FTIR spectrum scanning 0.5 grams of the second part is added to 5 mL of a TFA reactant solution, and the resulting mixture is subject to FTIR spectrum scanning. A differential spectrum is derived from the two FTIR spectra. The absorbance of the differential spectrum at 1672 cm⁻¹ relative to the absorbance at 2110 cm⁻¹ is input to the calibration equation to derive TBN for the sample. This FTIR method was an improvement over the ASTM titration methodology, a methodology commonly used to measure total base number in oil samples. This method is limited to mineral oils and requires two analyses to obtain a single result, thus involving more sample preparation and handling.

### SUMMARY

The present application is directed to a system and method for analysis of a predefined component (such as moisture content, acid content or carbonic base content) of matter. In one embodiment, a reagent is prepared where the reagent reacts with the predefined component to produce carbon dioxide gas. A number of standard mixtures are prepared in sealed vessels where the standard mixtures include the reagent and a component part where the reagent reacts with the component part of the standard mixtures to produce carbon dioxide gas in a manner analogous to the reaction of the reagent and the predefined component. The number of standard mixtures have different concentrations of the component part. FTIR analysis is performed on the contents of the sealed vessels that hold the standard mixtures in order to measure respective absorbances in one or more predefined spectral bands characteristic of carbon dioxide gas concentration. Such respective absorbances are used to derive a calibration equation that relates concentration of the predefined component to absorbance in the predefined spectral band(s) characteristic of carbon dioxide gas concentration. A mixture stored in a sealed vessel is derived from a sample and the reagent. The reagent reacts with the predefined component of the sample to produce carbon dioxide gas. FTIR analysis is performed on the content of the sealed vessel that holds the sample-derived reagent mixture in order to measure absorbance in the predefined spectral band characteristic of carbon dioxide gas concentration. Data that characterizes concentration of the predefined component in the sample is calculated based on the measured absorbance in the predefined spectral band characteristic of carbon dioxide gas concentration and the calibration equation. The data that characterizes concentration of the predefined component in the sample can be stored for output to a user.

In one embodiment, the sample can be a hydrophobic fluid sample, such as a lubricant, edible oil, transformer oil or fuel.

In another embodiment, the sample can be solid matrix, such as food stuff or a pharmaceutical.

The predefined spectral band can encompass the range between 2330 cm⁻¹ and 2340 cm⁻¹ (preferably at or near 2335 cm⁻¹).

In one embodiment, the sample-derived reagent mixture is prepared by reacting at least a portion of the sample with the reagent in the sealed vessel in order to produce an amount of carbon dioxide gas in the sealed vessel corresponding to the amount of the predefined component in the sample.

In another embodiment, the sample-derived reagent mixture is prepared by applying an extraction solvent to the sample to produce a liquid-phase extract that carries the predefined component of the sample, and reacting the liquid-phase extract with the reagent in the sealed vessel in order to produce an amount of carbon dioxide gas in the sealed vessel corresponding to the amount of the predefined component in the sample.

The FTIR analysis of the contents of the sealed vessels that hold the standard mixtures can include the derivation of differential spectrum data for the standard mixtures, and processing the differential spectrum data for the standard mixtures to derive final spectrum data for the standard mixtures. The FTIR analysis of the contents of the sealed vessel that holds the sample-derived reagent mixture can include the derivation of differential spectrum data for the sample-derived reagent mixture, and processing the differential spectrum data to derive final spectrum data for the sample-derived reagent mixture. The differential spectrum data can be based on a 5-5 (gap-segment) derivative of spectral data. The differential spectrum data can also be based on respective correction factors.

In one embodiment, the predefined component is moisture content of the sample. In this case, the reagent can include a compound (such as p-toluenesulfonyl isocyanate (TSI) or other homologous isocyanate) that reacts with moisture to produce carbon dioxide gas. The sample can be a hydrophobic fluid sample, and the reagent can further include an aprotic solvent that is miscible in the fluid sample or used to extract moisture from the fluid sample. For the case that miscibility is desired, the aprotic solvent of the reagent can be selected from the group consisting of toluene, tetrahydrofuran, and dioxane. For the case that extraction is desired, the aprotic solvent of the reagent can be selected from the group consisting of acetonitrile and DMSO. The moisture content of the aprotic solvent can be less than 100 parts per million to avoid unnecessary competitive consumption of moisture by the reagent. The component part of the standard mixtures can include water. The standard mixtures can further include dioxane as a diluent of the water.

In another embodiment, the predefined component is acid content of the sample. In this case, the reagent can include an alkali salt that reacts with acid content to produce carbon dioxide gas. The alkali salt can be selected from the group including sodium carbonate (Na₂CO₃) and potassium carbonate (K₂CO₃). The sample can be a hydrophobic fluid sample, and the reagent can further include water and a solvent that is miscible in the fluid sample or used to extract acid content from the fluid sample. The water can be present or added to the reagent to facilitate the reaction of the alkali salt and acid content of the sample. The solvent of the reagent can be selected from the group consisting of dioxane, tetrahyrofuran, toluene, propanol, 2-propanol, butanol, t-butanol, acetonitrile and DMSO. The component part of the standard mixtures can include an acid. The acid can be selected from the group consisting of weaker organic carboxylic acid such as oleic acid or hexanoic acid or strong acids such as HCl, perchloric acid, HBr, HF and sulfuric acid.

In yet another embodiment, the predefined component is carbonate base content of the sample (such as in the case of lubricants). In this case, the reagent can include an acid (such as HCl) that reacts with the carbonate base content to produce carbon dioxide gas. The sample can be a hydrophobic fluid sample, and the reagent can further include water and a solvent that is miscible in the fluid sample or used to extract carbonate base content from the fluid sample. The water can be present or added to the reagent to facilitate the reaction of the acid and the carbonate base content of the sample. The solvent of the reagent can be selected from the group consisting of dioxane, tetrahyrofuran, toluene, propanol, 2-propanol, butanol, t-butanol, acetonitrile and DMSO. The component part of the standard mixtures can include a base. The base content of the sample can be a metal carbonate, such as Na₂CO₃, NaHCO₃, CaCO₃ and MgCO₃.

In yet another embodiment, a system and method provides for analysis of total base content (including non-carbonate base content and carbonate base content) of the sample. In this embodiment, a reagent can be prepared that includes an acid that reacts with total base content of the sample (including both non-carbonate base content and carbonate base content of the sample) to produce an IR active salt at a concentration corresponding to the concentration of the total base content in the sample. The acid of the reagent also reacts with the carbonate base content of the sample to produce carbon dioxide gas at a concentration corresponding to the concentration of carbonate base content in the sample. The acid of the reagent can be trifluoroacetic acid (TFA, C₂HF₃O₂). In this case, trifluoroacetate anions are formed from the reaction of the TFA and the total base content of a sample, where the concentration of the resultant trifluoroacetate anions corresponds to the concentration of the total base content in the sample. The trifluoroacetate anions are an IR active salt that absorbs in the spectral range between 1666 cm⁻¹ and 1686 cm⁻¹ (preferably at or near 1676 cm⁻¹). Thus, the concentration of the trifluoroacetate anions can be measured by IR spectroscopic analysis of this spectral range to provide a measure of the total base content of the sample. Furthermore, with the reaction carried out in a sealed vessel, carbon dioxide gas is formed from the reaction of the TFA and the carbonate base content of the sample, where the concentration of the resultant carbon dioxide gas corresponds to the concentration of the carbonate base content of the sample. The carbon dioxide gas absorbs in the spectral range around 2330 cm⁻¹ and 2340 cm⁻¹ (preferably at or near 2335 cm⁻¹). Thus, the concentration of the carbon dioxide gas can be measured by IR spectroscopic analysis of these spectral range(s) to provide a measure of the carbonate base content in the sample. A measure of the non-carbonate base content in the sample can be calculated by subtracting the measure of carbonate base content in the sample from the measure of total base content in the sample. Such analysis can employ FTIR analysis of a number of calibration samples to derive first and second calibration equations. The first calibration equation relates absorbance in the predefined spectral band(s) characteristic of the IR active salt concentration to a measure of total base content (including both non-carbonate base content and carbonate base content) in the sample. The second calibration equation relates absorbance in one or more predefined spectral bands characteristic of carbon dioxide gas concentration to a measure of carbonate base content in the sample.

The system can include an infrared spectrometer, a cell for holding and evaluating a sample, and a computer or workstation equipped with data analysis software for analyzing the data measured by the infrared spectrometer. The system can also include equipment for facilitating manual and/or automated operation of the infrared spectrometer, sample testing, and data collection.

Additional objects and advantages of the present disclosure will become apparent to those skilled in the art upon reference to the detailed description taken in conjunction with the provided figures.

### BRIEF DESCRIPTION OF THE DRAWINGS

FIG. 1 is a schematic view of a system for performing FTIR spectroscopy in accordance with an embodiment of the present disclosure.

FIGS. 2A and 2B, collectively, is a flowchart showing a workflow for characterizing moisture content of a hydrophobic fluid sample in accordance with the present disclosure.

FIGS. 3A and 3B, collectively, is a flowchart showing a workflow for characterizing acid content of a hydrophobic fluid sample in accordance with the present disclosure.

FIGS. 4A and 4B, collectively, is a flowchart showing a workflow for characterizing carbonate base content of a hydrophobic fluid sample in accordance with the present disclosure.

FIGS. 5A and 5B, collectively, is a flowchart showing another workflow for characterizing moisture content of a sample in accordance with the present disclosure.

FIGS. 6A and 6B, collectively, is a flowchart showing another workflow for characterizing acid content of a sample in accordance with the present disclosure.

FIGS. 7A and 7B, collectively, is a flowchart showing another workflow for characterizing carbonate base content of a sample in accordance with the present disclosure.

FIGS. 8A, 8B and 8C, collectively, is a flowchart showing yet another workflow for characterizing total base contents of a hydrophobic sample in accordance with the present disclosure.

FIGS. 9A, 9B and 9C, collectively, is a flowchart showing still another workflow for characterizing total base content of a sample in accordance with the present disclosure.

### DETAILED DESCRIPTION OF THE PREFERRED EMBODIMENTS

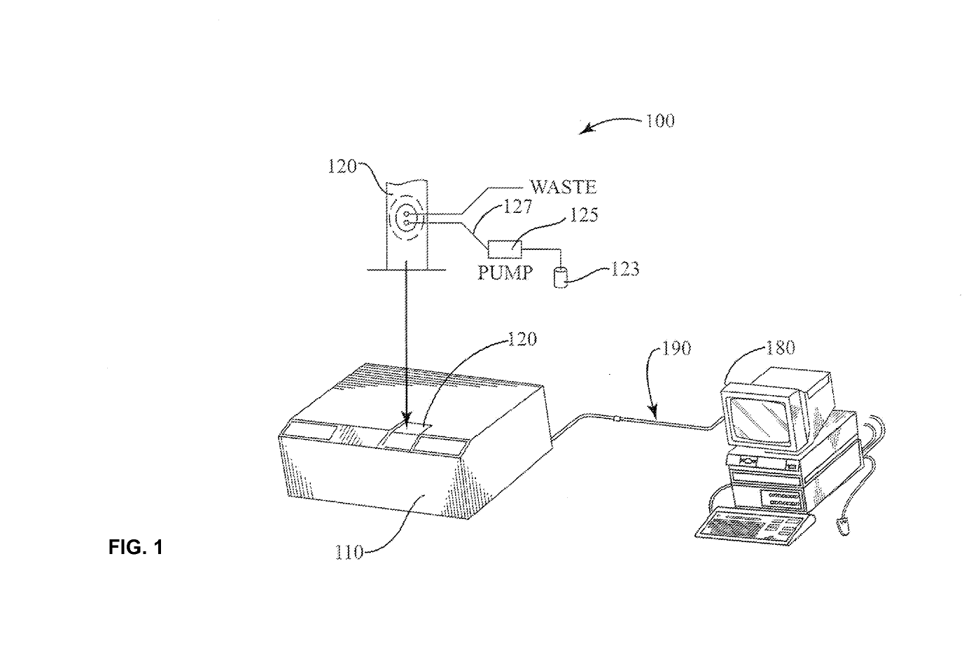

Turning to FIG. 1, a system 100 for performing FTIR spectroscopic analysis of a sample includes a spectrometer 110 for collecting IR absorption data of the sample as well as Fourier transform analysis and quantification of such IR absorption data to produce a corresponding infrared absorption spectrum (FTIR spectrum). The spectrometer 110 can be realized by a WorkIR series IR spectrometer, which is preferably equipped with a deuterated triglycine sulfate (DTGS) detector as sold commercially by ABB Analytical of Quebec, Canada. Other commercially-available IR spectrometers can also be used. A flow-through sample cell 120 is provided into which fluids from a sample vial may be loaded. In the preferred embodiment, the sample cell 120 can be realized by a CaF₂ or KCl transmission flow cell. Data acquired by the spectrometer 110 is communicated to a computer or workstation 180 via a data interface 190 (e.g., USB data interface or the like) for processing and analysis in accordance with the present invention. The computer 180 preferably includes a complete and fully integrated software package which is run at the computer 180 for analyzing the data and outputting information to a user (e.g., via a printer and/or on-screen). The software is configured to perform acquisition of IR absorption data measured by the spectrometer 110 as well as Fourier transform analysis and quantification of such IR absorption data to produce a corresponding infrared absorption spectrum (FTIR spectrum).

In one embodiment, the spectral acquisition parameters for the spectrometer 110 are set to the following:
resolution of 4 cm⁻¹;
triangular apodization is used to reduce ringing in the wings of the instrument line shape; this is achieved by applying the Fourier transform to an triangular apodization function in order to generate a convolution kernel, and applying a convolution between this kernel and the unapodized spectrum.
gain of 1;
spectral acquisition time of approximately 32 seconds; and
16 or 32 co-added scans, depending on whether the spectrometer 110 collects single-sided or double-sided interferograms.

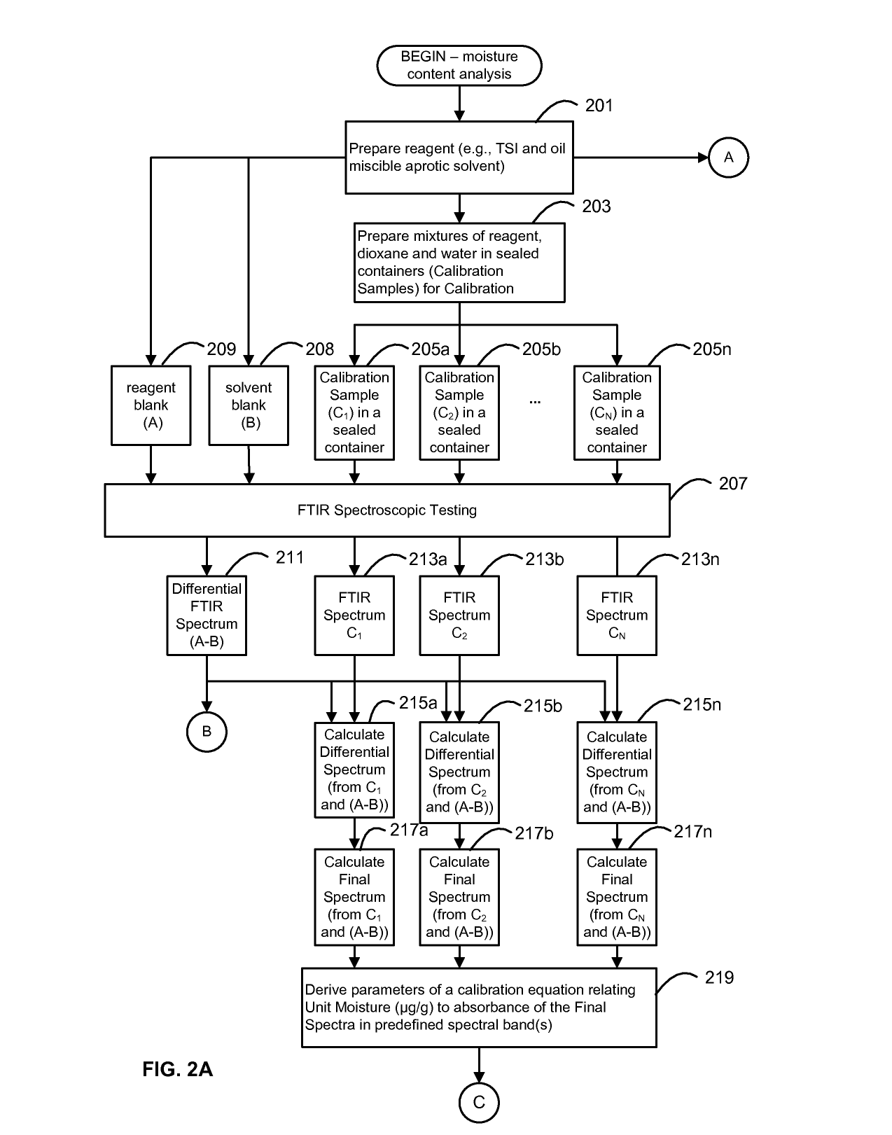

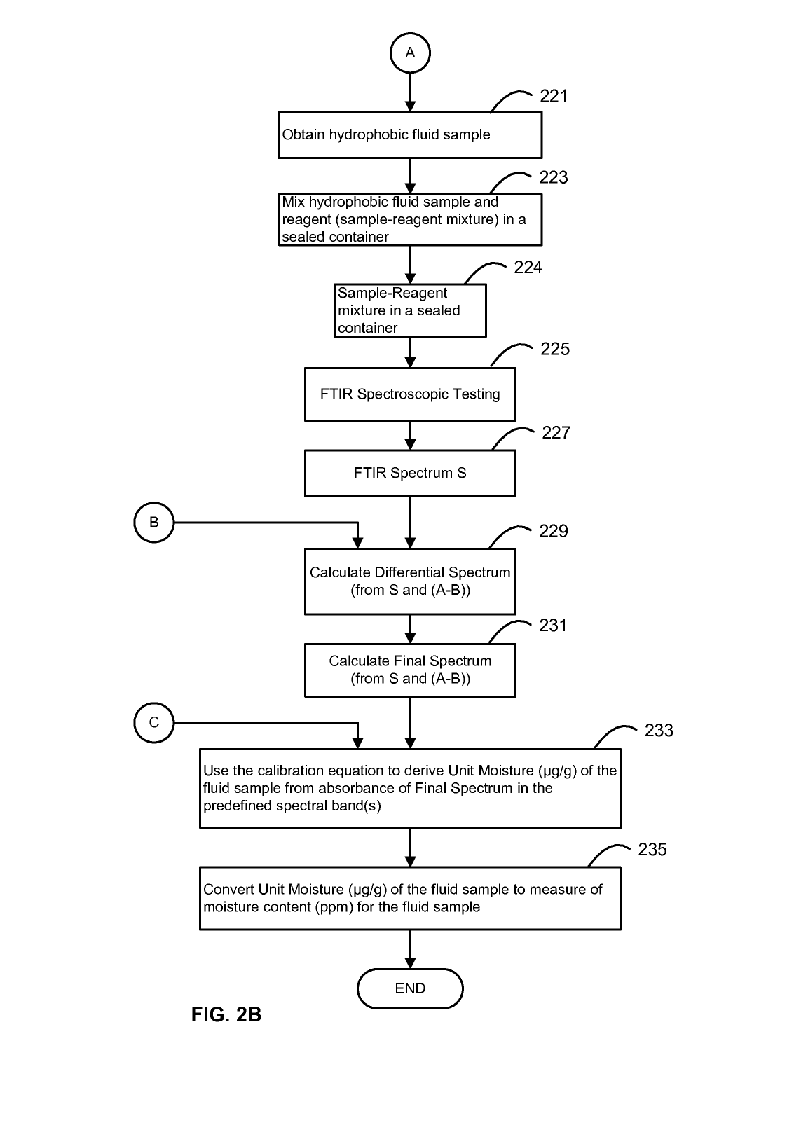

The system 100 of FIG. 1 can be used to perform the methodology of FIGS. 2A and 2B for generating data characterizing the moisture content of a generally hydrophobic fluid sample in accordance with the present disclosure. The method begins at block 201 with the preparation of a reagent. In one embodiment, the reagent is realized from a mixture of a compound (such as a p-toluenesulfonyl isocyanate (TSI) or a homolog isocyanate) that reacts with moisture to produce carbon dioxide gas and an aprotic solvent that is miscible in the hydrophobic fluid sample with low concentration of moisture. For example, the aprotic solvent can be dioxane, tetrahydrofuran, toluene, or other suitable aprotic solvent. The moisture content of the aprotic solvent is preferably less than 100 parts per million in order to minimize consumption of the reagent by the moisture in the solvent. Suitable material handling operations of the solvent can be taken to prevent ingress of atmospheric moisture during storage and dispensing of the solvent. In one embodiment, the reagent is prepared from p-toluenesulfonyl isocyanate (TSI) from Sigma-Aldrich of Oakville, ON, Canada. The p-toluenesulfonyl isocyanate (TSI) component of the reagent is chosen because it reacts with moisture to produce carbon dioxide in proportion to the concentration of the moisture as well as producing the corresponding TSI amide (TSA). This reaction is given as:

H₂O+TSI→TSA+CO₂ (1)

Furthermore, the p-toluenesulfonyl isocyanate (TSI) and solvent components of the reagent are chosen such that these components do not absorb in the same IR band as the spectral band around 2330 cm⁻¹ and 2340 cm⁻¹ (preferably at or near 2335 cm⁻¹) for carbon dioxide.

At block 203, the reagent of block 201 is mixed with dioxane and distilled water at different water concentration levels to produce a number of reagent-water mixtures (referred to herein as “calibration samples”) for calibration purposes. The n number of calibration samples are referred to as “C₁, C₂, . . . C_{N}” and labeled 205A, 205B . . . 205N in FIG. 2A. In one embodiment, the calibration samples 205A, 205B . . . 205N are prepared from a stock solution of approximately 100 grams of the reagent of block 201 and approximately 0.1 g of distilled water. The stock solution is intended to contain approximately 1000 ppm of water. In other embodiments, the concentration of water in the stock solution can be varied as desired depending on the range of the analysis. The concentration of moisture in the stock solution can be calculated from the ratio of the weight of the added distilled water to the weight of the added reagent of block 201. The stock solution can be diluted with dioxane at different weight concentrations to provide the desired calibration samples. The calibration samples C₁ . . . C_{N} can be stored in sealed vessels (e.g., sealed vials) that prevent the ingress of atmospheric moisture and carbon dioxide and the egress of carbon dioxide produced by the reaction of moisture (water content) with the p-toluenesulfonyl isocyanate (TSI) of the calibration samples C₁ . . . C_{N}. The headspace volumes of the sealed vessels can be controlled to provide low volume headspaces that minimize carbon dioxide in such headspaces when loading the sealed vessels, which facilitates a quantitative measure of carbon dioxide gas in solution that is produced by the reaction of moisture (water content) with the reagent of the calibration samples C₁ . . . C_{N}. Note that the dioxane and water components of calibration samples C₁ . . . C_{N} do not absorb in the same IR band as the spectral band around 2330 cm⁻¹ and 2340 cm⁻¹ (preferably at or near 2335 cm⁻¹) for carbon dioxide.

The aprotic solvent of block 201 is used to produce a solvent blank (labeled 208) and the reagent of block 201 is used to produce a reagent blank (labeled 209). In an illustrative embodiment, the solvent blank 208 is prepared by adding a predetermined quantity of the aprotic solvent of block 201 to a vessel (e.g., vial) and the reagent blank 209 is prepared by adding a predetermined quantity of the reagent of block 201 to a vessel (e.g. a vial). The vessels can be sealed to prevent ingress of atmospheric moisture and carbon dioxide.

In block 207, the spectrometer 110 is configured to perform FTIR spectroscopic analysis on the solvent blank 208, the reagent blank 209 as well as on each one of the calibration samples C₁, C₂ . . . C_{N}. The FTIR spectroscopic analysis of the calibration samples C₁, C₂ . . . C_{N} is performed after completion of the reaction of the moisture (water content) with reagent that produces carbon dioxide gas in the respective sealed vessels. The FTIR spectroscopic analysis of the solvent blank 208 and the reagent blank 209 produces a differential FTIR spectrum (A-B) (labeled 211) at the computer 180 by subtracting the FTIR spectrum B of the solvent blank 208 from the FTIR spectrum A of the reagent blank 209. The FTIR spectroscopic testing of the calibration sample C₁ produces an FTIR spectrum C₁ (labeled 213A) at the computer 180. The FTIR spectroscopic testing of the calibration sample C₂ produces an FTIR spectrum C₂ (labeled 213B) at the computer 180. FTIR spectra are generated for all of the remaining calibration samples C₃ . . . C_{N}.

In the preferred embodiment, a set-up procedure is performed as part of the analysis of the solvent blank, the reagent blank and each calibration sample. The set-up procedure typically involves cleaning the sample cell of the spectrometer 110 (for example, by washing with a solvent and drying by forcing air through the sample cell), performing an air background scan on the spectrometer 110, loading the fluid from the sealed vessel into the sample cell of the spectrometer 110, and configuring the operating parameters for the spectrometer 110 and computer 180. The loading of fluid from the sealed vessel into the sample cell of the spectrometer 110 can employ a double pipette arrangement. The double pipette arrangement includes a supply-side pipette that supplies inert gas under pressure into the sealed vessel to displace the fluid contained in the sealed vessel out a discharge-side pipette to the sample cell of the spectrometer. Examples of double pipette arrangements are disclosed in PCT/IB96/0084 and incorporated herein by reference in its entirety. Alternatively, the inert gas can manually pumped through the supply-side pipette to displace the fluid contained in the sealed vessel out a discharge-side pipette to the sample cell of the spectrometer. In the configuration, the flow line leading to the supply-side pipette (or the inlet of the supply-side pipette itself) can employ a check-valve that limits any backflow of carbon dioxide gas (or other fluid) from the sealed vessel out the supply-side pipette during the manual pumping process. After the set-up procedure is complete, the spectrometer 110 and computer 180 are operated to perform the experiment, collect the IR absorption data resulting from the experiment, and perform Fourier Transform processing on the collected IR absorption data to generate the FTIR spectrum for the respective sample.

In block 215A, the computer 180 calculates a differential spectrum for the calibration sample C₁ from the FTIR spectrum C₁ (labeled 213A) and the differential FTIR spectrum (A-B) (labeled 211). In block 215B, the computer 180 calculates a differential spectrum for the calibration sample C₂ from the FTIR spectrum C₂ (labeled 213B) and the differential FTIR spectrum (A-B) (labeled 211). Similar operations are performed by the computer 180 in blocks 215C . . . 215N to calculate differential spectra for the calibration samples C₃ . . . C_{N}. The processing that calculates the differential spectra can apply correction factors (or other compensation factors) to the measured FTIR spectra for the respective calibration samples C₁ . . . C_{N} to derive corrected spectra, and the differential FTIR spectrum (A-B) can be subtracted from the respective corrected spectra to calculate the differential spectra for the calibration samples C₁ . . . C_{N}. The use of the differential FTIR spectrum (A-B) compensates for any moisture present in the solvent component of the reagent. Alternatively, other suitable spectral processing can be used.

In block 217A, the computer 180 processes the differential spectrum of block 215A to calculate a final spectrum for the calibration sample C₁. In block 217B, the computer 180 processes the differential spectrum of block 215B to calculate a final spectrum for the calibration sample C₂. Similar operations are performed by the computer 180 in blocks 217C . . . 217N to calculate final spectra for the calibration samples C₃ . . . C_{N}. In the preferred embodiment, the final spectrum for the respective calibration sample is derived by taking 5-5 (gap segment) second derivative of the corresponding differential spectrum and multiplying the resultant second derivative by 100. The gap-segment second derivative serves the purpose of providing a stable baseline to measure to, sharpens bands and helps separate any overlapping bands, which minimizes spectral interferences.

The 5-5 (gap-segment) second derivative of the differential spectrum for each respective calibration mixture is preferably computed as follows. First, the absorbance value A(i) at each data point i of the differential spectrum is replaced by the mean absorbance value for a segment of 5 data points centered at data point i by:

A(i)=[A(i−2)+A(i−1)+A(i)+A(i+1)+A(i+2)]/5 (2)

A gap second derivative is then applied at each data point i by:

d²A(i)/dx₂=[−2A(i)+A(i+2g)+A(i−2g)]/4gΔx (3)

where Δx is the data point spacing in units of wavenumbers, and
g is set to 5 for the 5-5 (gap-segment) second derivative.
   The result at each data point i is multiplied by a scale factor (such as 100) to produce the final spectrum. The scale factor can be selected to make the spectra readable and not carry too many zeros so as to avoid multiplying very small numbers and losing significant digits. It is noted that measurements made on this second-derivative spectrum are referred to as absorbance (Abs) measurements for the sake of simplicity.

For example, the final spectrum for the calibration sample C₁ is derived by taking 5-5 (gap segment) second derivative of the differential spectrum of block 215A as described above. Alternatively, other suitable spectral processing can be used. It may be noted that the spectral values output by blocks 217A . . . 217N may not be in absorbance units but in arbitrary units, which are referred to as absorption measurements herein. It may also be noted that these measurements are not referenced to a spectral baseline point, because baseline offsets and tilts are not significant in second derivative spectra.

In block 219, the computer 180 utilizes the absorbance measurements of the final spectra derived in blocks 217A, 217B . . . 217N in the spectral band around 2330 cm⁻¹ and 2340 cm⁻¹ (preferably at or near 2335 cm⁻¹) to derive parameters of a calibration equation relating Unit Moisture (in μg/g) to absorbance of the final spectrum in such spectral band(s). Note that the water content of the calibration samples C₁ . . . C_{N} reacts with the reagent (e.g., p-toluenesulfonyl isocyanate (TSI)) of the calibration samples C₁ . . . C_{N} to produce carbon dioxide gas (CO₂) in a manner analogous to the reaction of the moisture content of the hydrophobic fluid sample and the reagent as described below. The carbon dioxide gas is a hydrophobic gas that is highly soluble in the hydrophobic fluid sample. With the reaction carried out in an enclosed vessel (septum-capped vial), the carbon dioxide gas can be readily contained and subjected to FTIR spectroscopic analysis carried out by the spectrometer 110. The absorbance in the spectral band around 2330 cm⁻¹ and 2340 cm⁻¹ (preferably at or near 2335 cm⁻¹) is characteristic of the amount of carbon dioxide gas produced by this reaction due to the fact that the carbon dioxide gas is a strong infrared absorber and absorbs in this spectral band where few other functional groups absorbs. Thus, the spectral band around 2330 cm⁻¹ and 2340 cm⁻¹ (preferably at or near 2335 cm⁻¹) is largely free of spectral interferences in terms of the quantification of carbon dioxide gas that results from the reaction in the enclosed vessel.

In one embodiment, the computer 180 can carry out linear regression on the Unit Moisture for the calibration mixtures and the absorbance of the final spectra derived in blocks 217A, 217B . . . 217N for the particular spectral band around 2330 cm⁻¹ and 2340 cm⁻¹ (preferably at or near 2335 cm⁻¹) to obtain the parameters (a, b) of a best fit equation of the form:

Unit Moisture(in μg/g)=a+b*Abs_{(2335 cm}_{^{−1}}₎. (4)

Importantly, the calibration equation relating Unit Moisture to absorbance for the particular spectral band is universal in that it is independent of the sample weight or the reagent volume used in the analysis of samples.

In block 221, a generally hydrophobic fluid sample is obtained. The hydrophobic fluid sample can be a lubricant, edible oil, transformer oil or a fuel such as biodiesel.

In block 223, at least a portion of the hydrophobic fluid sample of block 221 is mixed with the reagent of block 201 at or near a predetermined concentration to form a sample-reagent mixture where the amount of the reagent in the sample-reagent mixture exceeds the maximum moisture content analyzed for. In the preferred embodiment, approximately 12 grams of the hydrophobic fluid of block 221 is mixed with approximately 3 mL of the reagent of block 201 to provide a sample-reagent mixture of approximately 3% p-toluenesulfonyl isocyanate (TSI). The sample-reagent mixture is preferably stored in a vessel (such as a vial), which is sealed to prevent ingress of atmospheric moisture and carbon dioxide and the egress of carbon dioxide gas produced by the reaction of moisture content of the hydrophobic fluid sample and the reagent (e.g., p-toluenesulfonyl isocyanate (TSI)). The weight (in grams) of the hydrophobic fluid sample in the sample-reagent mixture is measured and recorded by the computer 180. The volume (in mL) of the reagent in the sample-reagent mixture is measured and recorded by the computer 180. The headspace volume of the sealed vessel can be controlled to provide low volume headspace that minimizes carbon dioxide in such headspace when loading the sealed vessel, which facilitates a quantitative measure of carbon dioxide gas in solution that is produced by the reaction of moisture (water content) with the reagent of the sample-reagent mixture. The sample-reagent mixture can be mixed (for example, by mixing on a vortex mixer or by agitating the sealed vessel in a sonicating water bath) at a predetermined temperature for a predetermined period of time in order to enhance the reaction of moisture content of the hydrophobic fluid sample and the reagent that forms carbon dioxide gas trapped in the sealed vessel.

In block 225, the spectrometer 110 is configured to perform FTIR spectroscopic analysis on the sample-reagent mixture to produce an FTIR spectrum S (labeled 227). The FTIR spectroscopic analysis of the sample-reagent mixture is performed after completion of the reaction of the moisture (water content) with the reagent that produces carbon dioxide gas in the sealed vessel (block 224).

In the preferred embodiment, a set-up procedure is performed as part of the analysis of the sample-reagent mixture. The set-up procedure typically involves cleaning the sample cell of the spectrometer 110 (for example, by washing with a solvent and drying by forcing air through the sample cell), performing an air background scan on the spectrometer 110, loading the sample-reagent mixture from the seal vessel into the sample cell of the spectrometer 110, and configuring the operating parameters for the spectrometer 110 and computer 180. The loading of the sample-reagent mixture from the sealed vessel into the sample cell of the spectrometer 110 can employ a double pipette arrangement. The double pipette arrangement includes a supply-side pipette that supplies inert gas under pressure into the sealed vessel to displace the fluid contained in the sealed vessel out a discharge-side pipette to the sample cell of the spectrometer. Examples of double pipette arrangements are disclosed in PCT/IB96/0084 and incorporated herein by reference in its entirety. Alternatively, the inert gas can manually pumped through the supply-side pipette to displace the fluid contained in the sealed vessel out a discharge-side pipette to the sample cell of the spectrometer. In the configuration, the flow line leading to the supply-side pipette (or the inlet of the supply-side pipette itself) can employ a check-valve that limits any backflow of carbon dioxide gas (or other fluid) from the sealed vessel out the supply-side pipette during the manual pumping process. After the set-up procedure is complete, the spectrometer 110 and computer 180 are operated to perform the experiment, collect the IR absorption data resulting from the experiment, and perform Fourier Transform processing on the collected IR absorption data to generate the FTIR spectrum for the sample-reagent mixture.

In block 229, the computer 180 calculates a differential spectrum for the sample-reagent mixture from the FTIR spectrum S (labeled 227) and the differential FTIR spectrum (A-B) (labeled 211). The processing that calculates the differential spectrum can apply a correction factor (or other compensation factor) to the measured FTIR spectrum S to derive a corrected spectrum, and the differential FTIR spectrum (A-B) can be subtracted from the corrected spectrum to calculate the differential spectrum for the sample-reagent mixture. The use of the differential FTIR spectrum (A-B) compensates for any moisture present in the solvent component of the reagent. Alternatively, other suitable spectral processing can be used.

In block 231, the computer 180 processes the differential spectrum for the sample-reagent mixture of block 229 to calculate a final spectrum for the sample-reagent mixture. In the preferred embodiment, the final spectrum for the sample-reagent mixture is derived by taking 5-5 (gap segment) second derivative of the corresponding differential spectrum as described above. The gap-segment second derivative serves the purpose of providing a stable baseline to measure to, sharpens bands and helps separate any overlapping bands, which minimizes the spectral interferences that can arise from miscibility of the fluid sample with the solvent used in preparing the reagent. Alternatively, other suitable spectral processing can be used. It may be noted that the spectral values output by block 231 may not be in absorbance units but in arbitrary units, which are referred to as absorption measurements herein. It may also be noted that these measurements are not referenced to a spectral baseline point, because baseline offsets and tilts are not significant in second derivative spectra.

In block 233, the computer 180 utilizes the absorbance measurements of the final spectrum of block 231 for the spectral band around 2330 cm⁻¹ and 2340 cm⁻¹ (preferably at or near 2335 cm⁻¹) as input to the calibration equation of block 219 to calculate Unit Moisture (in μg/g) of the sample-reagent mixture. Note that Unit Moisture represents the concentration of moisture in the fluid sample. Importantly, the calibration equation relating Unit Moisture to absorbance for the particular spectral band(s) is universal in that it is independent of the sample weight or reagent volume used in the analysis of samples. Note that the moisture (water content) of the fluid sample component of the sample-reagent mixture reacts with the reagent component (e.g., p-toluenesulfonyl isocyanate (TSI)) of the sample-reagent mixture to produce carbon dioxide gas (CO₂). The carbon dioxide gas is a hydrophobic gas that is highly soluble in the hydrophobic fluid sample. With the reaction carried out in an enclosed vessel (septum-capped vial), the carbon dioxide gas can be readily contained and subjected to FTIR spectroscopic analysis carried out by the spectrometer 110. The absorbance in the spectral band around 2330 cm⁻¹ and 2340 cm⁻¹ (preferably at or near 2335 cm⁻¹) is characteristic of the amount of carbon dioxide gas produced by this reaction due to the fact that the carbon dioxide gas is a strong infrared absorber and absorbs in this spectral band where few other functional groups absorbs. Thus, the spectral band around 2330 cm⁻¹ and 2340 cm⁻¹ (preferably at or near 2335 cm⁻¹) is largely free of spectral interferences in terms of the quantification of carbon dioxide gas that results from the reaction in the enclosed vessel.

In block 235, computer 180 converts the Unit Moisture (in μg/g) of the sample-reagent mixture of block 233 to a measure of moisture content (preferably in ppm) in the hydrophobic fluid sample. This measure of moisture content represents the concentration of moisture in the hydrophobic fluid sample. The moisture content of the hydrophobic fluid sample can be stored by the computer 180 and output to the user as desired.

Blocks 221-235 can be performed by automated (or semi-automated) fluid handling and measuring equipment as is well known in the art. Parts of blocks 221-235 can also be performed by manual fluid handling and measuring operations as is well known in the art.

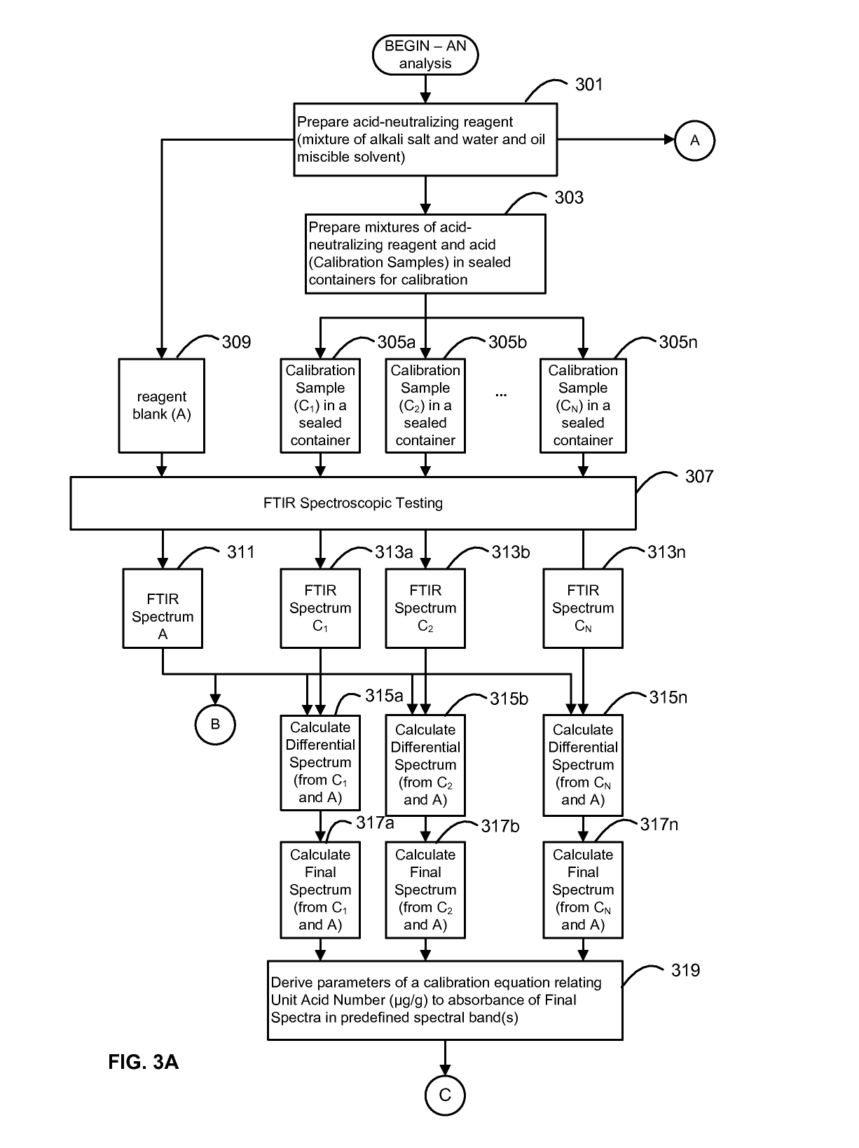

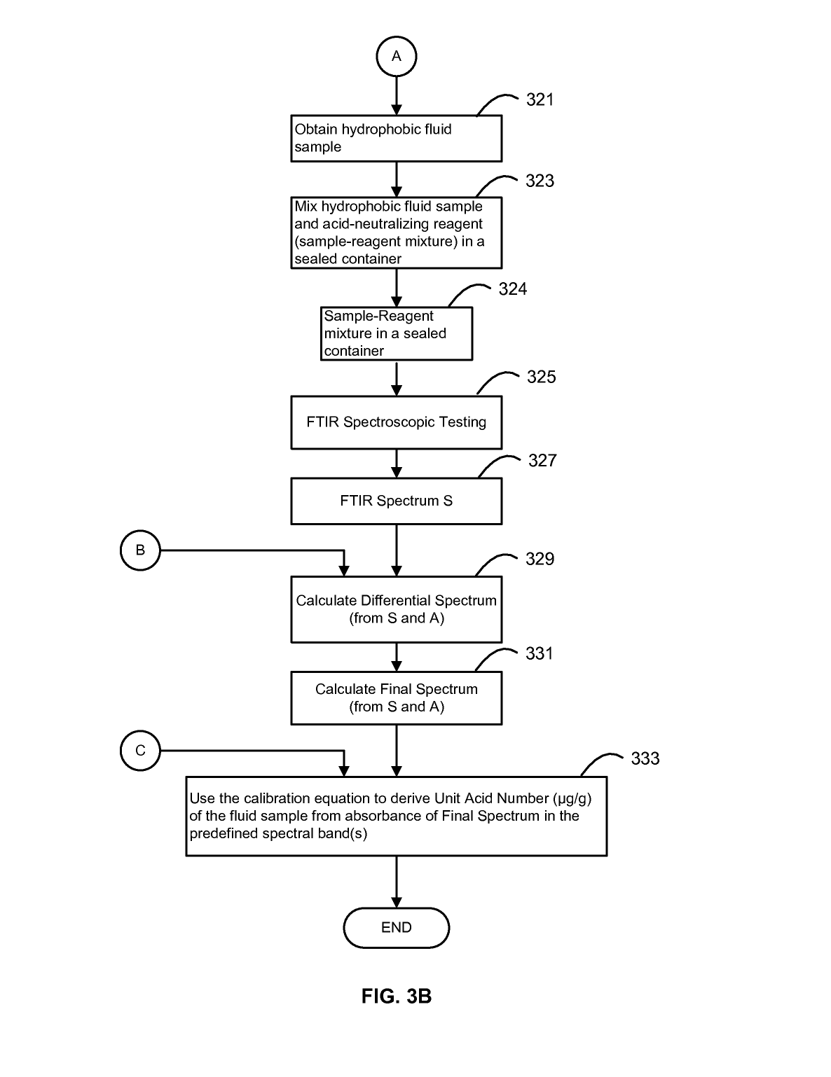

The system 100 of FIG. 1 can also be used to perform the methodology of FIGS. 3A and 3B for generating data characterizing the acidity (concentration of acid content) of a generally hydrophobic fluid sample in accordance with the present disclosure. The method begins at block 301 with the preparation of an acid-neutralizing reagent. In one embodiment, the acid-neutralizing reagent is realized from a mixture of an alkali salt (carbonate base) and water and an oil miscible solvent (such as dioxane, tetrahyrofuran, toluene, propanol, 2-propanol, butanol, t-butanol, acetonitrile and DMSO). The water can be present or added to the reagent to facilitate the reaction of the alkali salt and the acid content of the sample. The alkali salt (carbonate base) is chosen such that it reacts with acid components to produce carbon dioxide gas in proportion to the concentration of the acid components. Examples of suitable alkali salts include sodium carbonate (Na₂CO₃), potassium carbonate (K₂CO₃), calcium carbonate (CaCO₃) and manganese carbonate (MgCO₃). The reaction for the case of sodium carbonate (Na₂CO₃) is given as:

2R⁻H⁺+Na₂CO₃→2R⁻⁻Na⁺+H₂O+CO₂ (5)

Typical analyses cover a range of 0-4 mg KOH/g sample (for which approximately 12 g of the fluid sample is used) with the addition of approximately 3 ml of solvent containing sufficient water (typically, 1-5% water) to facilitate the acid-base reaction, and approximately 0.02 g of the alkali salt. Note that the alkali salt (carbonate base), water and solvent components of the acid-neutralizing reagent are chosen such that these components do not absorb in the same IR band as the spectral band around 2330 cm⁻¹ and 2340 cm⁻¹ (preferably at or near 2335 cm⁻¹) for carbon dioxide.

At block 303, the acid-neutralizing reagent of block 301 is mixed with an acid to produce a number of reagent-acid mixtures (referred to herein as “calibration samples”) at different acid concentration levels of the acid for calibration purposes. The n number of calibration samples are referred to as “C₁, C₂, . . . C_{N}” and labeled 305A, 305B . . . 305N in FIG. 3A. The acid can be a weaker organic carboxylic acid such as oleic acid or hexanoic acid, or a stronger acid such as HCl, perchloric acid, HBr, HF and sulfuric acid. The acid is selected such that it does not absorb in the same IR band as the spectral band around 2330 cm⁻¹ and 2340 cm⁻¹ (preferably at or near 2335 cm⁻¹) for carbon dioxide. The calibration samples C₁ . . . C_{N} can be stored in sealed vials that prevent the ingress of atmospheric carbon dioxide and the egress of carbon dioxide produced by the reaction of the acid content with the acid-neutralizing reagent of the calibration samples C₁ . . . C_{N}. The headspace volumes of the sealed vessels can be controlled to provide low volume headspaces that minimizes carbon dioxide in such headspaces when loading the sealed vessels, which facilitates a quantitative measure of carbon dioxide gas in solution that is produced by the reaction of the acid content with the alkali salt of the calibration samples C₁ . . . C_{N}.

The acid-neutralizing reagent of block 301 is also used to produce a reagent blank (labeled 309). In an illustrative embodiment, the reagent blank 309 is prepared by adding a predetermined quantity of the acid-neutralizing reagent of block 301 to a vessel (e.g., vial). The vessel can be sealed to prevent ingress of atmospheric carbon dioxide.

In block 307, the spectrometer 110 is configured to perform FTIR spectroscopic analysis on the reagent blank 309 (labeled A) as well as on each one of the calibration mixtures C₁, C₂ . . . C_{N}. The FTIR spectroscopic analysis of the calibration samples C₁, C₂ . . . C_{N} is performed after completion of the reaction of the acid content with the alkali salt (carbonate base) that produces carbon dioxide gas in the respective sealed vessels. The FTIR spectroscopic analysis of the reagent blank 309 produces an FTIR spectrum A (labeled 311) at the computer 180. The FTIR spectroscopic testing of the calibration sample C₁ produces an FTIR spectrum C₁ (labeled 313A) at the computer 180. The FTIR spectroscopic testing of the calibration sample C₂ produces an FTIR spectrum C₂ (labeled 313B) at the computer 180. FTIR spectra are generated for all of the remaining calibration samples C₃ . . . C_{N}.

In the preferred embodiment, a set-up procedure is performed as part of the analysis of the reagent blank and each calibration sample. The set-up procedure typically involves cleaning the sample cell of the spectrometer 110 (for example, by washing with a solvent and drying by forcing air through the sample cell), performing a background scan on the spectrometer 110, loading the fluid from the sealed vessel into the sample cell of the spectrometer 110, and configuring the operating parameters for the spectrometer 110 and computer 180. The loading of fluid from the sealed vessel into the sample cell of the spectrometer 110 can employ a double pipette arrangement. The double pipette arrangement includes a supply-side pipette that supplies inert gas under pressure into the sealed vessel to displace the fluid contained in the sealed vessel out a discharge-side pipette to the sample cell of the spectrometer. Examples of double pipette arrangements are disclosed in PCT/IB96/0084 and incorporated herein by reference in its entirety. Alternatively, the inert gas can manually pumped through the supply-side pipette to displace the fluid contained in the sealed vessel out a discharge-side pipette to the sample cell of the spectrometer. In the configuration, the flow line leading to the supply-side pipette (or the inlet of the supply-side pipette itself) can employ a check-valve that limits any backflow of carbon dioxide gas (or other fluid) from the sealed vessel out the supply-side pipette during the manual pumping process. After the set-up procedure is complete, the spectrometer 110 and computer 180 are operated to perform the experiment, collect the IR absorption data resulting from the experiment, and perform Fourier Transform processing on the collected IR absorption data to generate the FTIR spectrum for the respective sample.

In block 315A, the computer 180 calculates a differential spectrum for the calibration sample C₁ from the FTIR spectrum C₁ (labeled 313A) and the FTIR spectrum A (labeled 311). In block 315B, the computer 180 calculates a differential spectrum for the calibration sample C₂ from the FTIR spectrum C₂ (labeled 313B) and the FTIR spectrum A (labeled 311). Similar operations are performed by the computer 180 in blocks 315C . . . 315N to calculate differential spectra for the calibration samples C₃ . . . C_{N}. The processing that calculates the differential spectra can apply correction factors (or other compensation factors) to the measured FTIR spectra for the respective calibration samples C₁ . . . C_{N} to derive corrected spectra, and the FTIR spectrum A can be subtracted from the respective corrected spectra to calculate the differential spectra for the calibration samples C₁ . . . C_{N}. Alternatively, other suitable spectral processing can be used.

In block 317A, the computer 180 processes the differential spectrum of block 315A to calculate a final spectrum for the calibration sample C₁. In block 317B, the computer 180 processes the differential spectrum of block 315B to calculate a final spectrum for the calibration sample C₂. Similar operations are performed by the computer 180 in blocks 317C . . . 317N to calculate final spectra for the calibration samples C₃ . . . C_{N}. In the preferred embodiment, the final spectrum for the respective calibration sample is derived by taking 5-5 (gap segment) second derivative of the corresponding differential spectrum and multiplying the resultant second derivative by 100. The gap-segment second derivative serves the purpose of providing a stable baseline to measure to, sharpens bands and helps separate any overlapping bands, which minimizes spectral interferences.

In block 319, the computer 180 utilizes the absorbance measurements of the final spectra derived in blocks 317A, 317B . . . 317N in the spectral band around 2330 cm⁻¹ and 2340 cm⁻¹ (preferably at or near 2335 cm⁻¹) to derive parameters of a calibration equation relating Unit Acid Number (in μg/g) to absorbance of the final spectrum in such spectral band(s).

Note that the acid content of the calibration samples C₁ . . . C_{N} reacts with the alkali salt (carbonate base) of the calibration samples C₁ . . . C_{N} to produce carbon dioxide gas in a manner analogous to the reaction of the acid content of the hydrophobic fluid sample and the acid-neutralizing reagent as described below. The carbon dioxide gas is a hydrophobic gas that is highly soluble in the hydrophobic fluid sample. With the reaction carried out in a sealed vessel (septum-capped vial), the carbon dioxide gas can be readily contained and subjected to FTIR spectroscopic analysis carried out by the spectrometer 110. The absorbance in the spectral band around 2330 cm⁻¹ and 2340 cm⁻¹ (preferably at or near 2335 cm⁻¹) is characteristic of the amount of carbon dioxide gas produced by this reaction due to the fact that the carbon dioxide gas is a strong infrared absorber and absorbs in this spectral band where few other functional groups absorbs. Thus, the spectral band around 2330 cm⁻¹ and 2340 cm⁻¹ (preferably at or near 2335 cm⁻¹) is largely free of spectral interferences in terms of the quantification of carbon dioxide gas that results from the reaction in the enclosed vessel.

The computer 180 can carry out linear regression on the Unit Acid Number for the calibration mixtures and the absorbance of the final spectra derived in blocks 317A, 317B . . . 317N for the spectral and around 2330 cm⁻¹ and 2340 cm⁻¹ (preferably at or near 2335 cm⁻¹) to obtain the parameters (a, b) of a best fit equation of the form:

Unit Acid Number(in μg/g)=a+b*Abs(2335 cm⁻¹). (6)

Importantly, the calibration equation relating Unit Acid Number to absorbance for the particular spectral band is universal in that it is independent of the sample weight or the reagent volume used in the analysis of samples.

In block 321, a generally hydrophobic fluid sample is obtained. The hydrophobic fluid sample can be a lubricant, edible oil, transformer oil or a fuel such as biodiesel.

In block 323, at least a portion of the hydrophobic fluid sample of block 321 is mixed with the acid-neutralizing reagent of block 301 at or near a predetermined concentration to form a sample-reagent mixture. In the preferred embodiment, approximately 12 grams of the hydrophobic fluid of block 321 is mixed with approximately 3 mL of the wet solvent of the reagent of block 301, and then an excess of the alkali salt (carbonate base) of the reagent of block 301 (an amount in excess of the maximum acidity analyzed for) is added to the mixture. The sample-reagent mixture is preferably stored in a vessel (such as a vial), which is sealed to prevent ingress of atmospheric carbon dioxide and the egress of carbon dioxide gas produced by the reaction of acid content of the hydrophobic fluid sample and the alkali salt of the acid-neutralizing reagent. The weight (in grams) of the hydrophobic fluid sample in the sample-reagent mixture is measured and recorded by the computer 180. The volume (in mL) of the acid-neutralizing reagent in the sample-reagent mixture is measured and recorded by the computer 180. The headspace volume of the sealed vessel can be controlled to provide low volume headspace that minimizes carbon dioxide in such headspace when loading the sealed vessel, which facilitates a quantitative measure of carbon dioxide gas in solution that is produced by the reaction of the acid content with the alkali salt (carbonate base) of the sample-reagent mixture. The sample-reagent mixture can be mixed (for example, by mixing in a vortex mixer or by agitating the sealed vessel in a sonicating water bath) at a predetermined temperature for a predetermined period of time in order to enhance the reaction of the acid content of the hydrophobic fluid sample and the alkali salt (carbonate base) of the acid-neutralizing reagent that forms carbon dioxide gas trapped in the sealed vessel.

In block 325, the spectrometer 110 is configured to perform FTIR spectroscopic analysis on the sample-reagent mixture to produce an FTIR spectrum S (labeled 327). The FTIR spectroscopic analysis of the sample-reagent mixture is performed after completion of the reaction of the acid content with the alkali salt of the reagent that produces carbon dioxide gas in the sealed vessel (block 324).

In the preferred embodiment, a set-up procedure is performed as part of the analysis of the sample-reagent mixture. The set-up procedure typically involves cleaning the sample cell of the spectrometer 110 (for example, by washing with a solvent and drying by forcing air through the sample cell), performing a background scan on the spectrometer 110, loading the sample-reagent mixture from the sealed vessel into the sample cell of the spectrometer 110, and configuring the operating parameters for the spectrometer 110 and computer 180. The loading of the sample-reagent mixture from the sealed vessel into the sample cell of the spectrometer 110 can employ a double pipette arrangement. The double pipette arrangement includes a supply-side pipette that supplies inert gas under pressure into the sealed vessel to displace the fluid contained in the sealed vessel out a discharge-side pipette to the sample cell of the spectrometer. Examples of double pipette arrangements are disclosed in PCT/IB96/0084 and incorporated herein by reference in its entirety. Alternatively, the inert gas can manually pumped through the supply-side pipette to displace the fluid contained in the sealed vessel out a discharge-side pipette to the sample cell of the spectrometer. In the configuration, the flow line leading to the supply-side pipette (or the inlet of the supply-side pipette itself) can employ a check-valve that limits any backflow of carbon dioxide gas (or other fluid) from the sealed vessel out the supply-side pipette during the manual pumping process. After the set-up procedure is complete, the spectrometer 110 and computer 180 are operated to perform the experiment, collect the IR absorption data resulting from the experiment, and perform Fourier Transform processing on the collected IR absorption data to generate the FTIR spectrum for the sample-reagent mixture.

In block 329, the computer 180 calculates a differential spectrum for the sample-reagent mixture from the FTIR spectrum S (labeled 327) and the FTIR spectrum A (labeled 311). The processing that calculates the differential spectrum can apply a correction factor (or other compensation factor) to the measured FTIR spectrum S to derive a corrected spectrum, and the FTIR spectrum A can be subtracted from the corrected spectrum to calculate the differential spectrum for the sample-reagent mixture. Alternatively, other suitable spectral processing can be used.

In block 331, the computer 180 processes the differential spectrum for the sample-reagent mixture of block 329 to calculate a final spectrum for the sample-reagent mixture. In the preferred embodiment, the final spectrum for the sample-reagent mixture is derived by taking 5-5 (gap segment) second derivative of the corresponding differential spectrum as described above. The gap-segment second derivative serves the purpose of providing a stable baseline to measure to, sharpens bands and helps separate any overlapping bands, which minimizes the spectral interferences that can arise from miscibility of the fluid sample with the solvent used in preparing the acid-neutralizing reagent. Alternatively, other suitable spectral processing can be used. It may be noted that the spectral values output by block 331 may not be in absorbance units but in arbitrary units, which are referred to as absorption measurements herein. It may also be noted that these measurements are not referenced to a spectral baseline point, because baseline offsets and tilts are not significant in second derivative spectra.

In block 333, the computer 180 utilizes the absorbance measurements of the final spectrum of block 331 for the spectral band around 2330 cm⁻¹ and 2340 cm⁻¹ (preferably at or near 2335 cm⁻¹) as input to the calibration equation of block 319 to calculate Unit Acid Number (in μg/g) of the fluid sample. Importantly, the calibration equation relating Unit Acid Number to absorbance for the particular spectral band(s) is universal in that it is independent of the sample weight or reagent volume used in the analysis of samples. The Unit Acid Number (in μg/g) of the fluid sample can be stored by the computer 180 and output to the user as desired. The Unit Acid Number (in μg/g) represents acidity (concentration of acid components) of the fluid sample, which can develop as a result of oxidation of oils, the accumulation of combustion by-products in oils or both. Such acidity is conventionally measured by potentiometric titration by its stoichiometric reaction with a strong base.

Note that the acid content of the fluid sample component of the sample-reagent mixture reacts with the alkali salt (carbonate base) of the acid-neutralizing reagent of the sample-reagent mixture to produce carbon dioxide gas (CO₂). The carbon dioxide gas is a hydrophobic gas that is highly soluble in the hydrophobic fluid sample. With the reaction carried out in an enclosed vessel (septum-capped vial), the carbon dioxide gas can be readily contained and subjected to FTIR spectroscopic analysis carried out by the spectrometer 110. The absorbance in the spectral band around 2330 cm⁻¹ and 2340 cm⁻¹ (preferably at or near 2335 cm⁻¹) is characteristic of the amount of carbon dioxide gas produced by this reaction due to the fact that the carbon dioxide gas is a strong infrared absorber and absorbs in this spectral band where few other functional groups absorbs. Thus, the spectral band around 2330 cm⁻¹ and 2340 cm⁻¹ (preferably at or near 2335 cm⁻¹) is largely free of spectral interferences in terms of the quantification of carbon dioxide gas that results from the reaction in the enclosed vessel.

Blocks 321-333 can be performed by automated (or semi-automated) fluid handling and measuring equipment as is well known in the art. Parts of blocks 321-333 can also be performed by manual fluid handling and measuring operations as is well known in the art.

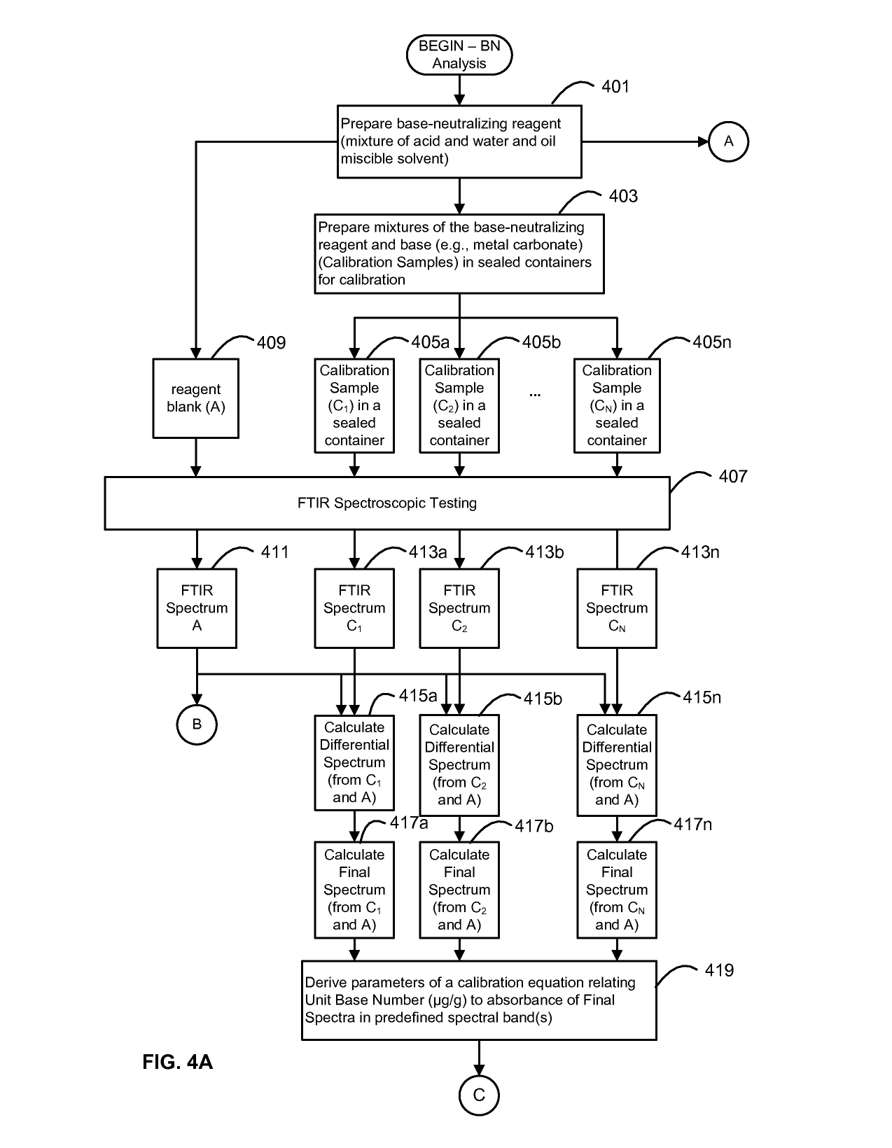

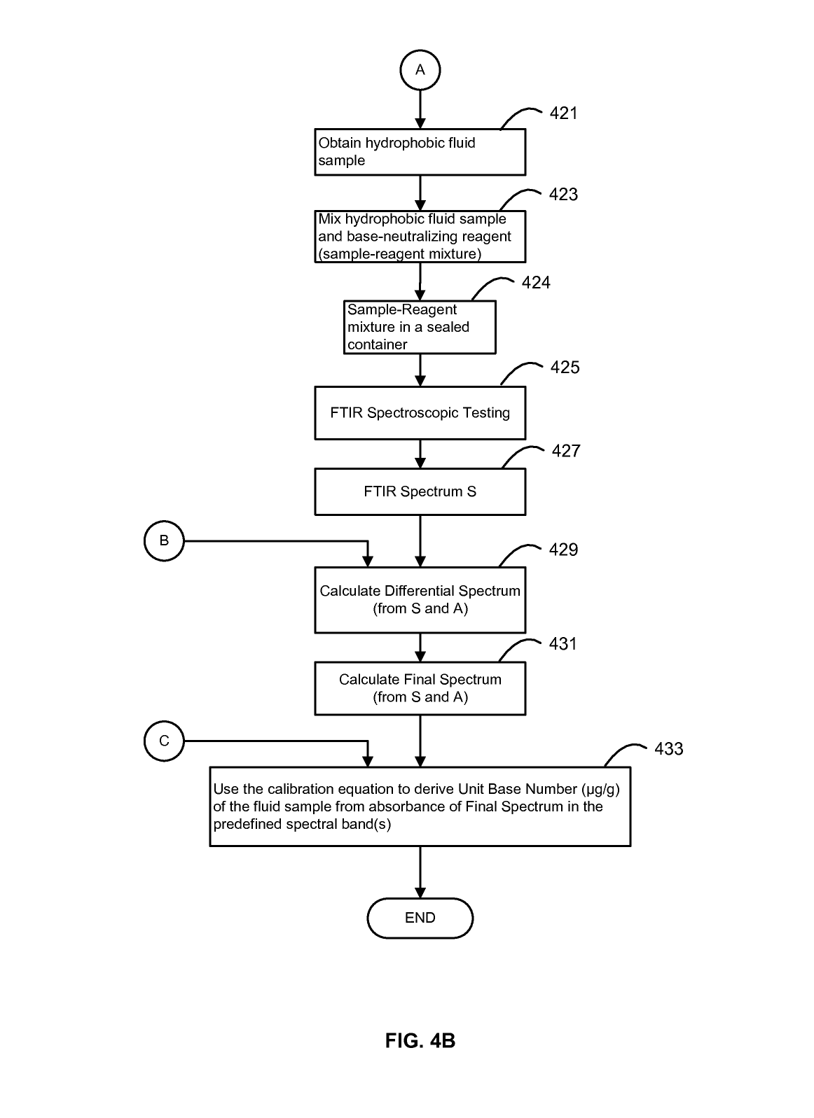

The system 100 of FIG. 1 can also be used to perform the methodology of FIGS. 4A and 4B for generating data characterizing the basicity (concentration of base content) of a generally hydrophobic fluid sample in accordance with the present disclosure. The methodology is particularly suited to characterizing the concentration of carbonate base content of the generally hydrophobic fluid sample. The method begins at block 401 with the preparation of a base-neutralizing reagent. In one embodiment, the base-neutralizing reagent is realized from a mixture of an acid and water and an oil miscible solvent (such as dioxane, tetrahyrofuran, toluene, propanol, 2-propanol, butanol, t-butanol, acetonitrile and DMSO). The water can be present or added to the reagent to facilitate the reaction of the acid and the base content of the sample. The acid is chosen such that it reacts with base components (typically metal carbonate bases such as CaCO₃ and MgCO₃ that are added to hydrophobic fluids such as lubricants to neutralize acids being produced and introduced into such fluids) to produce carbon dioxide gas in proportion to the concentration of the base components. The acid can be a weaker organic carboxylic acid such as oleic acid or hexanoic acid, or a stronger acid such as HCl, perchloric acid, HBr, HF and sulfuric acid. The reaction for the case of HCl with a metal carbonate additive of CaCO₃ is given as:

2CaCO₃+2HCl→CaCl₂+2CO₂+H₂O (7)

Note that the acid, water and solvent components of the base-neutralizing reagent are chosen such that these components do not absorb in the same IR band as the spectral band around 2330 cm-1 and 2340 cm-1 (preferably at or near 2335 cm-1) for carbon dioxide as well as the spectral band around 660 cm⁻¹ and 680 cm⁻¹ (preferably at or near 670 cm⁻¹) for carbon dioxide.

At block 403, the base-neutralizing reagent of block 401 is mixed with a carbonate base (such as NaHCO₃, KHCO₃, CaCO₃ and MgCO₃) to produce a number of reagent-base mixtures (referred to herein as “calibration samples”) at different predefined concentrations of the carbonate base. The n number of calibration samples are referred to as “C₁, C₂, . . . C_{N}” and labeled 405A, 405B . . . 405N in FIG. 4A. The base of the calibration samples C₁ . . . C_{N} is chosen such that it does not absorb in the same IR band as the spectral band around 2330 cm⁻¹ and 2340 cm⁻¹ (preferably at or near 2335 cm⁻¹) for carbon dioxide as well as the spectral band around 660 cm⁻¹ and 680 cm⁻¹ (preferably at or near 670 cm⁻¹) for carbon dioxide. The calibration samples C₁ . . . C_{N} can be stored in sealed vials that prevent the ingress of atmospheric carbon dioxide and the egress of carbon dioxide produced by the reaction of the base content with the base-neutralizing reagent of the calibration samples C₁ . . . C_{N}. The headspace volumes of the sealed vessels can be controlled to provide low volume headspaces that minimizes carbon dioxide in such headspaces when loading the sealed vessels, which facilitates a quantitative measure of carbon dioxide gas in solution that is produced by the reaction of the acid and base content of the calibration samples C₁ . . . C_{N}.

The base-neutralizing reagent of block 401 is also used to produce a reagent blank (labeled 409). In an illustrative embodiment, the reagent blank 409 is prepared by adding a predetermined quantity of the base-neutralizing reagent of block 401 to a vessel (e.g., a vial). The vessel can be sealed to prevent ingress of atmospheric carbon dioxide.

In block 407, the spectrometer 110 is configured to perform FTIR spectroscopic analysis on the reagent blank 409 (labeled A) as well as on each one of the calibration samples C₁, C₂ . . . C_{N}. The FTIR spectroscopic analysis of the calibration samples C₁, C₂ . . . C_{N} is performed after completion of the reaction of the acid and base content that produces carbon dioxide gas in the respective sealed vessels. The FTIR spectroscopic analysis of the reagent blank 409 produces an FTIR spectrum A (labeled 411) at the computer 180. The FTIR spectroscopic testing of the calibration sample C₁ produces an FTIR spectrum C₁ (labeled 413A) at the computer 180. The FTIR spectroscopic testing of the calibration sample C₂ produces an FTIR spectrum C₂ (labeled 413B) at the computer 180. FTIR spectra are generated for all of the remaining calibration samples C₃ . . . C_{N}.

In the preferred embodiment, a set-up procedure is performed as part of the analysis of the reagent blank and each calibration sample. The set-up procedure typically involves cleaning the sample cell of the spectrometer 110 (for example, by washing with a solvent and drying by forcing air through the sample cell), performing a background scan on the spectrometer 110, loading the fluid sample from the sealed vessel into the sample cell of the spectrometer 110, and configuring the operating parameters for the spectrometer 110 and computer 180. The loading of fluid from the sealed vessel into the sample cell of the spectrometer 110 can employ a double pipette arrangement. The double pipette arrangement includes a supply-side pipette that supplies inert gas under pressure into the sealed vessel to displace the fluid contained in the sealed vessel out a discharge-side pipette to the sample cell of the spectrometer. Examples of double pipette arrangements are disclosed in PCT/IB96/0084 and incorporated herein by reference in its entirety. Alternatively, the inert gas can manually pumped through the supply-side pipette to displace the fluid contained in the sealed vessel out a discharge-side pipette to the sample cell of the spectrometer. In the configuration, the flow line leading to the supply-side pipette (or the inlet of the supply-side pipette itself) can employ a check-valve that limits any backflow of carbon dioxide gas (or other fluid) from the sealed vessel out the supply-side pipette during the manual pumping process. After the set-up procedure is complete, the spectrometer 110 and computer 180 are operated to perform the experiment, collect the IR absorption data resulting from the experiment, and perform Fourier Transform processing on the collected IR absorption data to generate the FTIR spectrum for the respective sample.

In block 415A, the computer 180 calculates a differential spectrum for the calibration sample C₁ from the FTIR spectrum C₁ (labeled 413A) and the FTIR spectrum A (labeled 411). In block 415B, the computer 180 calculates a differential spectrum for the calibration sample C₂ from the FTIR spectrum C₂ (labeled 413B) and the FTIR spectrum A (labeled 411). Similar operations are performed by the computer 180 in blocks 415C . . . 415N to calculate differential spectra for the calibration samples C₃ . . . C_{N}. The processing that calculates the differential spectra can apply correction factors (or other compensation factors) to the measured FTIR spectra for the respective calibration samples C₁ . . . C_{N} to derive corrected spectra, and the FTIR spectrum A can be subtracted from the respective corrected spectra to calculate the differential spectra for the calibration samples C₁ . . . C_{N}. Alternatively, other suitable spectral processing can be used.

In block 417A, the computer 180 processes the differential spectrum of block 415A to calculate a final spectrum for the calibration sample C₁. In block 417B, the computer 180 processes the differential spectrum of block 415B to calculate a final spectrum for the calibration sample C₂. Similar operations are performed by the computer 180 in blocks 417C . . . 417N to calculate final spectra for the calibration samples C₃ . . . C_{N}. In the preferred embodiment, the final spectrum for the respective calibration sample is derived by taking 5-5 (gap segment) second derivative of the corresponding differential spectrum and multiplying the resultant second derivative by 100. The gap-segment second derivative serves the purpose of providing a stable baseline to measure to, sharpens bands and helps separate any overlapping bands, which minimizes spectral interferences.

In block 419, the computer 180 utilizes the absorbance measurements of the final spectra derived in blocks 417A, 417B . . . 417N in the spectral band around 2330 cm⁻¹ and 2340 cm⁻¹ (preferably at or near 2335 cm⁻¹) to derive parameters of a calibration equation relating Unit Base Number (in μg/g) to absorbance of the final spectrum in such spectral band(s).

Note that the base content of the calibration samples C₁ . . . C_{N} reacts with the base-neutralizing agent of the calibration samples C₁ . . . C_{N} to produce carbon dioxide gas (CO₂) in a manner analogous to the reaction of the base content of the hydrophobic fluid sample with the base-neutralizing agent as described below. The carbon dioxide gas is a hydrophobic gas that is highly soluble in the hydrophobic fluid sample. With the reaction carried out in a sealed vessel (septum-capped vial), the carbon dioxide gas can be readily contained and subjected to FTIR spectroscopic analysis carried out by the spectrometer 110. The absorbance in the spectral band around 2330 cm⁻¹ and 2340 cm⁻¹ (preferably at or near 2335 cm⁻¹) is characteristic of the amount of carbon dioxide gas produced by this reaction due to the fact that the carbon dioxide gas is a strong infrared absorber and absorbs in this spectral band where few other functional groups absorbs. Thus, the spectral band around 2330 cm⁻¹ and 2340 cm⁻¹ (preferably at or near 2335 cm⁻¹) is largely free of spectral interferences in terms of the quantification of carbon dioxide gas that results from the reaction in the enclosed vessel.

The computer 180 can carry out linear regression on the Unit Base Number for the calibration mixtures and the absorbance of the final spectra derived in blocks 417A, 417B . . . 417N for the spectral band around 2330 cm⁻¹ and 2340 cm⁻¹ (preferably at or near 2335 cm⁻¹) to obtain the parameters (a, b) of a best fit equation of the form:

Unit Base Number(in μg/g)=a+b*Abs(2335 cm⁻¹). (8)

Importantly, the calibration equation relating Unit Base Number to absorbance for the particular spectral band is universal in that it is independent of the sample weight or the reagent volume used in the analysis of samples.

In block 421, a generally hydrophobic fluid sample is obtained. The hydrophobic fluid sample can be a lubricant, edible oil, transformer oil or a fuel such as biodiesel.

In block 423, at least a portion of the hydrophobic fluid sample of block 421 is mixed with the base-neutralizing reagent of block 401 at or near a predetermined concentration to form a sample-reagent mixture where the amount of the base-neutralizing reagent exceeds the maximum base content analyzed for. In the preferred embodiment, approximately 12 grams of the hydrophobic fluid of block 421 is mixed with approximately 3 mL of the base-neutralizing reagent of block 401. The sample-reagent mixture is preferably stored in a vessel (such as a vial), which is sealed to prevent ingress of atmospheric carbon dioxide and the egress of carbon dioxide gas produced by the reaction of base content of the hydrophobic fluid sample and the base-neutralizing reagent of the sample-reagent mixture. The weight (in grams) of the hydrophobic fluid sample in the sample-reagent mixture is measured and recorded by the computer 180. The volume (in mL) of the base-neutralizing reagent in the sample-reagent mixture is measured and recorded by the computer 180. The headspace volume of the sealed vessel can be controlled to provide low volume headspace that minimizes carbon dioxide in such headspace when loading the sealed vessel, which facilitates a quantitative measure of carbon dioxide gas in solution that is produced by the reaction of the acid and base-neutralizing reagent of the sample-reagent mixture. The sample-reagent mixture can be mixed (for example, by mixing the sealed vessel in a vortex mixer or by agitating the sealed vessel in a sonicating water bath) at a predetermined temperature for a predetermined period of time in order to enhance the reaction of the base content of the hydrophobic fluid sample and the base-neutralizing reagent of the sample-reagent mixture that forms carbon dioxide gas trapped in the sealed vessel.

In block 425, the spectrometer 110 is configured to perform FTIR spectroscopic analysis on the sample-reagent mixture to produce an FTIR spectrum S (labeled 427). The FTIR spectroscopic analysis of the sample-reagent mixture is performed after completion of the reaction of the base content with the reagent that produces carbon dioxide gas in the sealed vessel (block 424).

In the preferred embodiment, a set-up procedure is performed as part of the analysis of the sample-reagent mixture. The set-up procedure typically involves cleaning the sample cell of the spectrometer 110 (for example, by washing with a solvent and drying by forcing air through the sample cell), performing a background scan on the spectrometer 110, loading the sample-reagent mixture from the sealed vessel into the sample cell of the spectrometer 110, and configuring the operating parameters for the spectrometer 110 and computer 180. The loading of the sample-reagent mixture from the sealed vessel into the sample cell of the spectrometer 110 can employ a double pipette arrangement. The double pipette arrangement includes a supply-side pipette that supplies inert gas under pressure into the sealed vessel to displace the fluid contained in the sealed vessel out a discharge-side pipette to the sample cell of the spectrometer. Examples of double pipette arrangements are disclosed in PCT/IB96/0084 and incorporated herein by reference in its entirety. Alternatively, the inert gas can manually pumped through the supply-side pipette to displace the fluid contained in the sealed vessel out a discharge-side pipette to the sample cell of the spectrometer. In the configuration, the flow line leading to the supply-side pipette (or the inlet of the supply-side pipette itself) can employ a check-valve that limits any backflow of carbon dioxide gas (or other fluid) from the sealed vessel out the supply-side pipette during the manual pumping process. After the set-up procedure is complete, the spectrometer 110 and computer 180 are operated to perform the experiment, collect the IR absorption data resulting from the experiment, and perform Fourier Transform processing on the collected IR absorption data to generate the FTIR spectrum for the sample-reagent mixture.

In block 429, the computer 180 calculates a differential spectrum for the sample-reagent mixture from the FTIR spectrum S (labeled 427) and the FTIR spectrum A (labeled 411). The processing that calculates the differential spectrum can apply a correction factor (or other compensation factor) to the measured FTIR spectrum S to derive a corrected spectrum, and the FTIR spectrum A can be subtracted from the corrected spectrum to calculate the differential spectrum for the sample-reagent mixture. Alternatively, other suitable spectral processing can be used.

In block 431, the computer 180 processes the differential spectrum for the sample-reagent mixture of block 429 to calculate a final spectrum for the sample-reagent mixture. In the preferred embodiment, the final spectrum for the sample-reagent mixture is derived by taking 5-5 (gap segment) second derivative of the corresponding differential spectrum as described above. The gap-segment second derivative serves the purpose of providing a stable baseline to measure to, sharpens bands and helps separate any overlapping bands, which minimizes the spectral interferences that can arise from miscibility of the fluid sample with the solvent used in preparing the acid-neutralizing reagent. Alternatively, other suitable spectral processing can be used. It may be noted that the spectral values output by block 431 may not be in absorbance units but are referred to as absorption measurements herein. It may also be noted that these measurements are not referenced to a spectral baseline point, because baseline offsets and tilts are not significant in second derivative spectra.

In block 433, the computer 180 utilizes the absorbance measurements of the final spectrum of block 431 for the spectral band around 2330 cm⁻¹ and 2340 cm⁻¹ (preferably at or near 2335 cm⁻¹) as input to the calibration equation of block 419 to calculate Unit Base Number (in μg/g) of the fluid sample. Importantly, the calibration equation relating Unit Base Number to absorbance for the particular spectral band is universal in that it is independent of the sample weight or reagent volume used in the analysis of samples. The Unit Base Number (in μg/g) of the fluid sample can be stored by the computer 180 and output to the user as desired. The Unit Base Number (in μg/g) represents the basicity (concentration of base content) of the fluid sample. Such basicity is conventionally measured by potentiometric titration by its stoichiometric reaction with a strong acid. Note that the base content of the fluid sample component of the sample-reagent mixture reacts with the base-neutralizing reagent of the sample-reagent mixture to produce carbon dioxide gas. The carbon dioxide gas is a hydrophobic gas that is highly soluble in the hydrophobic fluid sample. With the reaction carried out in an enclosed vessel (septum-capped vial), the carbon dioxide gas can be readily contained and subjected to FTIR spectroscopic analysis carried out by the spectrometer 110. The absorbance in the spectral band around 2330 cm⁻¹ and 2340 cm⁻¹ (preferably at or near 2335 cm⁻¹) is characteristic of the amount of carbon dioxide gas produced by this reaction due to the fact that the carbon dioxide gas is a strong infrared absorber and absorbs in this spectral band where few other functional groups absorbs. Thus, the spectral band around 2330 cm⁻¹ and 2340 cm⁻¹ (preferably at or near 2335 cm⁻¹) is largely free of spectral interferences in terms of the quantification of carbon dioxide gas that results from the reaction in the enclosed vessel.

Blocks 421-433 can be performed by automated (or semi-automated) fluid handling and measuring equipment as is well known in the art. Parts of blocks 421-433 can also be performed by manual fluid handling and measuring operations as is well known in the art.

The system and the methodology described above can be adapted to generate data characterizing certain constituent components (such as moisture, acid content and base content) of a wide range of materials (including liquids such as hydrophobic fluids, and solid matrices such as foodstuffs and pharmaceuticals). In this case, it is possible to extract the desired constituent component (such as moisture, acid content and base content) from the sample and then react a reagent with the extract in a sealed vessel in a manner that produces carbon dioxide at an amount that corresponds to the amount of the desired constituent component in the sample. The amount of carbon dioxide can be measured by FTIR spectroscopy and input to a calibration equation to produce data that represents the relative concentration of the desired constituent component in the sample in a manner similar to the methods described above.

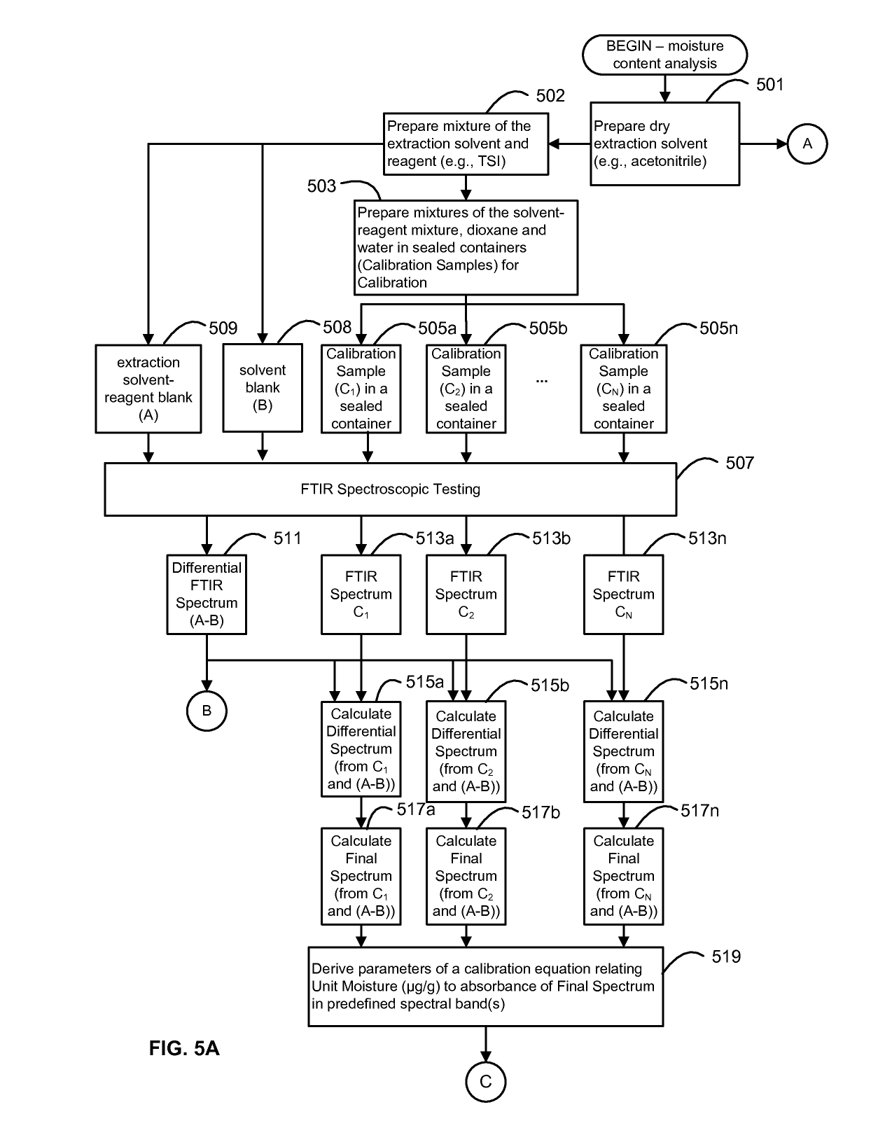

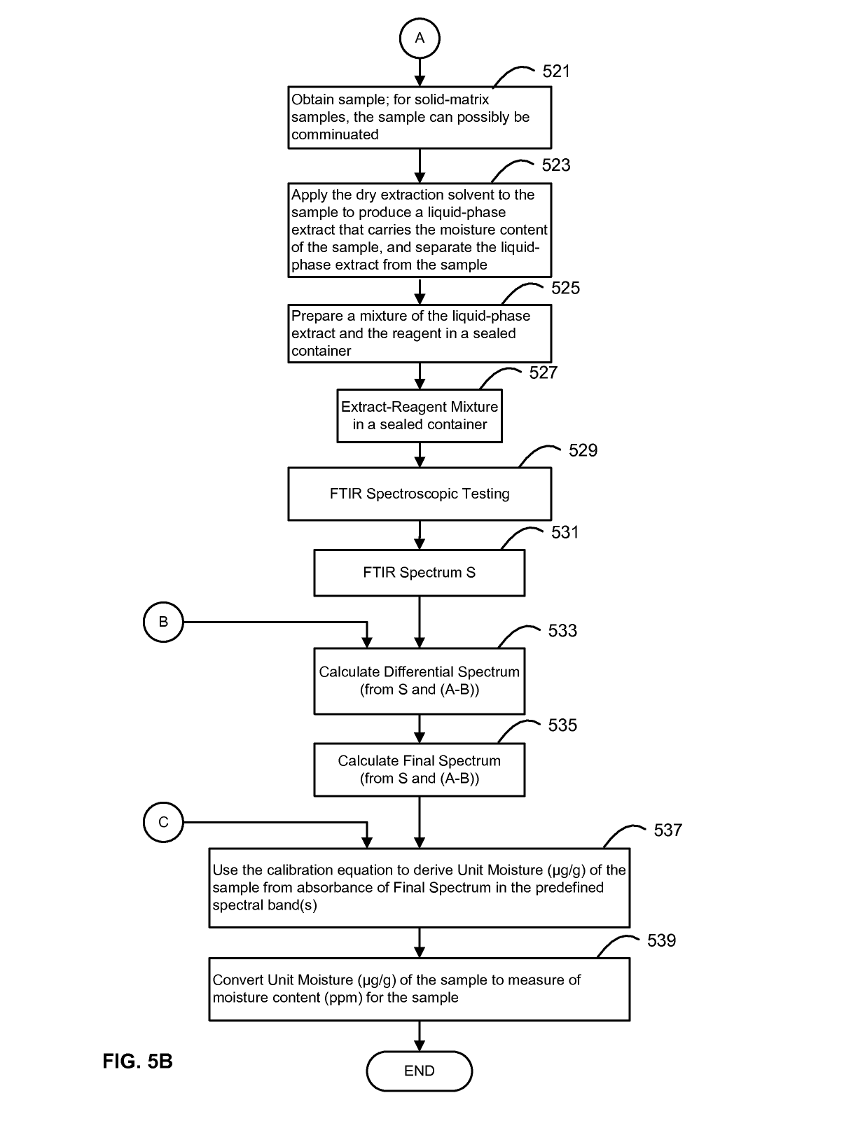

In one example, the system 100 of FIG. 1 can be used to perform the methodology of FIGS. 5A and 5B for generating data characterizing the moisture content of a sample in accordance with the present disclosure. The method begins at block 501 with the preparation of an extraction solvent with low concentration of moisture, which is referred to as a “dry extraction solvent” herein. The dry extraction solvent is chosen such that it is an aprotic solvent miscible in water and functions to extract moisture from a sample such that moisture is transferred to the extraction solvent or extract. In one embodiment, the dry extraction solvent is realized from acetonitrile, dimethyl sulfoxide (DMSO), tetrahydrofuran, dioxane or toluene or combinations thereof. The moisture content of the extraction solvent is preferably less than 100 parts per million in order to minimize consumption of the reagent by the moisture in the solvent. Suitable material handling operations of the solvent can be taken to prevent ingress of atmospheric moisture during storage and dispensing of the solvent. The operations of block 501 can also involve preparing a reagent that includes a compound (such as p-toluenesulfonyl isocyanate (TSI) or homolog isocyanate) that reacts with moisture content to produce carbon dioxide in proportion to the concentration of the moisture content. In one embodiment, the reagent is prepared from p-toluenesulfonyl isocyanate (TSI) from Sigma-Aldrich of Oakville, ON, Canada. The p-toluenesulfonyl isocyanate (TSI) component of the reagent is chosen because it reacts with moisture to produce carbon dioxide in proportion to the concentration of the moisture content as described above with respect to Eqn. (1).

At block 502, a mixture is prepared that includes the dry extraction solvent and the reagent of block 501. In the preferred embodiment, approximately 100 ml of the dry extraction solvent of block 501 is mixed with approximately 3% of the reagent.

At block 503, the extraction solvent-reagent mixture of block 502 is mixed with dioxane and distilled water to produce a number of extraction solvent-reagent-water mixtures (referred to herein as “calibration samples”) at different water concentration levels for calibration purposes. The n number of calibration samples are referred to as “C₁, C₂, . . . C_{N}” and labeled 505A, 505B . . . 505N in FIG. 5A. In one embodiment, the calibration samples 505A, 505B . . . 505N are prepared from a stock solution of the extraction solvent-reagent mixture of block 502 and distilled water. The stock solution is intended to contain approximately 1000 ppm of water. The concentration of moisture in the stock solution can be calculated from the ratio of the weight of the added distilled water to the weight of the extraction solvent-reagent mixture of block 502. The stock solution can be diluted with dioxane at different weight concentrations to provide the desired calibration samples. The calibration samples C₁ . . . C_{N} can be stored in sealed vessels (e.g., vials) that prevent the ingress of atmospheric moisture and carbon dioxide and the egress of carbon dioxide produced by the reaction of moisture (water content) with the reagent (e.g., p-toluenesulfonyl isocyanate (TSI)) of the calibration samples C₁ . . . C_{N}. The headspace volumes of the sealed vessels can be controlled to provide low volume headspaces that minimizes carbon dioxide in such headspaces when loading the sealed vessels, which facilitates a quantitative measure of carbon dioxide gas in solution that is produced by the reaction of moisture (water content) with the reagent of the calibration samples C₁ . . . C_{N}. Note that the dioxane and water components of calibration samples C₁ . . . C_{N} do not absorb in the same IR band as the spectral band around 2330 cm⁻¹ and 2340 cm⁻¹ (preferably at or near 2335 cm⁻¹) for carbon dioxide.

The dry extraction solvent is used to produce a solvent blank (labeled 508), and the extraction solvent-reagent mixture of block 502 is used to produce a reagent blank (labeled 509). In an illustrative embodiment, the solvent blank is prepared by adding a predetermined quantity of the dry extraction solvent of block 501 to a vessel (e.g., a vial), and the reagent blank 509 is prepared by adding a predetermined quantity of the extraction solvent-reagent mixture of block 502 to a vessel (e.g. a vial). The vessels can be sealed to prevent ingress of atmospheric moisture and carbon dioxide.

In block 507, the spectrometer 110 is configured to perform FTIR spectroscopic analysis on the reagent blank 509 (labeled A), the extraction solvent blank 508 (labeled B) as well as on each one of the calibration samples C₁, C₂ . . . C_{N}. The FTIR spectroscopic analysis of the calibration samples C₁, C₂ . . . C_{N} is performed after completion of the reaction of the moisture (water content) with the reagent that produces carbon dioxide gas in the respective sealed vessels. The FTIR spectroscopic analysis of the reagent blank 509 and the extraction solvent blank 508 produces a differential FTIR spectrum (A-B) (labeled 511) at the computer 180 by subtracting the FTIR spectrum B of the solvent blank 508 from the FTIR spectrum A of the reagent blank 509. The FTIR spectroscopic testing of the calibration sample C₁ produces an FTIR spectrum C₁ (labeled 513A) at the computer 180. The FTIR spectroscopic testing of the calibration sample C₂ produces an FTIR spectrum C₂ (labeled 513B) at the computer 180. FTIR spectra are generated for all of the remaining calibration samples C₃ . . . C_{N}.

In the preferred embodiment, a set-up procedure is performed as part of the analysis of the reagent blank, the extraction solvent blank and each calibration sample. The set-up procedure typically involves cleaning the sample cell of the spectrometer 110 (for example, by washing with a solvent and drying by forcing air through the sample cell), performing a background scan on the spectrometer 110, loading the fluid from the sealed vessel into the sample cell of the spectrometer 110, and configuring the operating parameters for the spectrometer 110 and computer 180. The loading of fluid from the sealed vessel into the sample cell of the spectrometer 110 can employ a double pipette arrangement. The double pipette arrangement includes a supply-side pipette that supplies inert gas under pressure into the sealed vessel to displace the fluid contained in the sealed vessel out a discharge-side pipette to the sample cell of the spectrometer. Examples of double pipette arrangements are disclosed in PCT/IB96/0084 and incorporated herein by reference in its entirety. Alternatively, the inert gas can manually pumped through the supply-side pipette to displace the fluid contained in the sealed vessel out a discharge-side pipette to the sample cell of the spectrometer. In the configuration, the flow line leading to the supply-side pipette (or the inlet of the supply-side pipette itself) can employ a check-valve that limits any backflow of carbon dioxide gas (or other fluid) from the sealed vessel out the supply-side pipette during the manual pumping process. After the set-up procedure is complete, the spectrometer 110 and computer 180 are operated to perform the experiment, collect the IR absorption data resulting from the experiment, and perform Fourier Transform processing on the collected IR absorption data to generate the FTIR spectrum for the respective sample.

In block 515A, the computer 180 calculates a differential spectrum for the calibration sample C₁ from the FTIR spectrum C₁ (labeled 513A) and the differential FTIR spectrum (A-B) (labeled 511). In block 515B, the computer 180 calculates a differential spectrum for the calibration sample C₂ from the FTIR spectrum C₂ (labeled 513B) and the differential FTIR spectrum (A-B) (labeled 511). Similar operations are performed by the computer 180 in blocks 515C . . . 515N to calculate differential spectra for the calibration samples C₃ . . . C_{N}. The processing that calculates the differential spectra can apply correction factors (or other compensation factors) to the measured FTIR spectra for the respective calibration samples C₁ . . . C_{N} to derive corrected spectra, and the differential FTIR spectrum (A-B) can be subtracted from the respective corrected spectra to calculate the differential spectra for the calibration samples C₁ . . . C_{N}. The use of the differential FTIR spectrum (A-B) compensates for any moisture present in the extraction solvent. Alternatively, other suitable spectral processing can be used.

In block 517A, the computer 180 processes the differential spectrum of block 515A to calculate a final spectrum for the calibration sample C₁. In block 517B, the computer 180 processes the differential spectrum of block 515B to calculate a final spectrum for the calibration sample C₂. Similar operations are performed by the computer 180 in blocks 517C . . . 517N to calculate final spectra for the calibration samples C₃ . . . C_{N}. In the preferred embodiment, the final spectrum for the respective calibration sample is derived by taking 5-5 (gap segment) second derivative of the corresponding differential spectrum and multiplying the resultant second derivative by 100.

In block 519, the computer 180 utilizes the absorbance measurements of the final spectra derived in blocks 517A, 517B . . . 517N in the spectral band around 2330 cm⁻¹ and 2340 cm⁻¹ (preferably at or near 2335 cm⁻¹) to derive parameters of a calibration equation relating Unit Moisture (in μg/g) to absorbance of the final spectrum in such spectral band(s).

Note that the water content of the calibration samples C₁ . . . C_{N} reacts with the p-toluenesulfonyl isocyanate (TSI) of the calibration samples C₁ . . . C_{N} to produce carbon dioxide gas (CO₂) in a manner analogous to the reaction of the moisture content contained in the sample extract and the reagent of the extraction solvent-reagent mixture as described below. With the reaction carried out in a sealed vessel (septum-capped vial), the carbon dioxide gas can be readily contained and subjected to FTIR spectroscopic analysis carried out by the spectrometer 110. The absorbance in the spectral band around 2330 cm⁻¹ and 2340 cm⁻¹ (preferably at or near 2335 cm⁻¹) is characteristic of the amount of carbon dioxide gas produced by this reaction due to the fact that the carbon dioxide gas is a strong infrared absorber and absorbs in this spectral band where few other functional groups absorbs. Thus, the spectral band around 2330 cm⁻¹ and 2340 cm⁻¹ (preferably at or near 2335 cm⁻¹) is largely free of spectral interferences in terms of the quantification of carbon dioxide gas that results from the reaction in the enclosed vessel.

The computer 180 can carry out linear regression on the Unit Moisture for the calibration mixtures and the absorbance of the final spectra derived in blocks 517A, 517B . . . 517N for the spectral band around 2330 cm⁻¹ and 2340 cm⁻¹ (preferably at or near 2335 cm⁻¹) to obtain the parameters (a, b) of a best fit equation of the form:

Unit Moisture(in μg/g)=a+b*Abs_{(2335 cm}_{^{−1}}₎. (9)

Importantly, the calibration equation relating Unit Moisture to absorbance for the particular spectral band is universal in that it is independent of the sample weight or the reagent volume used in the analysis of samples.

In block 521, a sample of interest is obtained. The sample of interest can be a liquid (such as a hydrophobic fluid) or solid matrix (such as food stuff or a pharmaceutical). In the case that the sample is a solid matrix, it can possibly be comminuted in block 521, if desired.

In block 523, the dry extraction solvent of block 501 is applied to the sample (or parts thereof) to produce a liquid-phase extract that carries the moisture content of the sample. The liquid-phase extract is separated from the sample (or sample parts) for subsequent processing, if need be.

In block 525, a mixture is prepared that includes the liquid-phase extract produced in block 523 (which carries the moisture content of the sample) and the reagent (e.g., TSI) where the amount of the reagent exceeds the maximum moisture content analyzed for. In the preferred embodiment, approximately 12 ml of the liquid-phase extract is mixed with approximately 3 ml of the reagent. The extract-reagent mixture is preferably stored in a vessel (such as a vial), which is sealed to prevent ingress of atmospheric moisture and carbon dioxide and the egress of carbon dioxide gas produced by the reaction of moisture content of the hydrophobic fluid sample and the reagent. The weight (in grams) of the sample from which the extract is derived is measured and recorded by the computer 180. The volume (in mL) of the reagent in the extract-reagent mixture is measured and recorded by the computer 180. The headspace volume of the sealed vessel can be controlled to provide low volume headspace that minimizes carbon dioxide in such headspace when loading the sealed vessel, which facilitates a quantitative measure of carbon dioxide gas in solution that is produced by the reaction of moisture (water content) with the reagent of the extract-reagent mixture. The extract-reagent mixture can be mixed (for example, by mixing the sealed vessel in a vortex mixer or agitating the sealed vessel in a sonicating water bath) at a predetermined temperature for a predetermined period of time in order to enhance the reaction of moisture content of the hydrophobic fluid sample (as contained in the extract) and the reagent that forms carbon dioxide gas trapped in the sealed vessel.

In block 529, the spectrometer 110 is configured to perform FTIR spectroscopic analysis on the extract-reagent mixture to produce an FTIR spectrum S (labeled 531). The FTIR spectroscopic analysis of the extract-reagent mixture is performed after completion of the reaction of the moisture (water content) with the reagent that produces carbon dioxide gas in the sealed vessel (block 527).

In the preferred embodiment, a set-up procedure is performed as part of the analysis of the extract-reagent mixture. The set-up procedure typically involves cleaning the sample cell of the spectrometer 110 (for example, by washing with a solvent and drying by forcing air through the sample cell), performing a background scan on the spectrometer 110, loading the extract-reagent mixture from the seal vessel into the sample cell of the spectrometer 110, and configuring the operating parameters for the spectrometer 110 and computer 180. The loading of the extract-reagent mixture from the sealed vessel into the sample cell of the spectrometer 110 can employ a double pipette arrangement. The double pipette arrangement includes a supply-side pipette that supplies inert gas under pressure into the sealed vessel to displace the fluid contained in the sealed vessel out a discharge-side pipette to the sample cell of the spectrometer. Examples of double pipette arrangements are disclosed in PCT/IB96/0084 and incorporated herein by reference in its entirety. Alternatively, the inert gas can manually pumped through the supply-side pipette to displace the fluid contained in the sealed vessel out a discharge-side pipette to the sample cell of the spectrometer. In the configuration, the flow line leading to the supply-side pipette (or the inlet of the supply-side pipette itself) can employ a check-valve that limits any backflow of carbon dioxide gas (or other fluid) from the sealed vessel out the supply-side pipette during the manual pumping process. After the set-up procedure is complete, the spectrometer 110 and computer 180 are operated to perform the experiment, collect the IR absorption data resulting from the experiment, and perform Fourier Transform processing on the collected IR absorption data to generate the FTIR spectrum for the sample-reagent mixture.

In block 533, the computer 180 calculates a differential spectrum for the extract-reagent mixture from the FTIR spectrum S (labeled 531) and the differential FTIR spectrum (A-B) (labeled 511). The processing that calculates the differential spectrum can apply a correction factor (or other compensation factor) to the measured FTIR spectrum S to derive a corrected spectrum, and the differential FTIR spectrum (A-B) can be subtracted from the corrected spectrum to calculate the differential spectrum for the extract-reagent mixture. The use of the differential FTIR spectrum (A-B) compensates for any moisture present in the extraction solvent. Alternatively, other suitable spectral processing can be used.

In block 535, the computer 180 processes the differential spectrum for the extract-reagent mixture of block 533 to calculate a final spectrum for the extract-reagent mixture. In the preferred embodiment, the final spectrum for the extract-reagent mixture is derived by taking 5-5 (gap segment) second derivative of the corresponding differential spectrum as described above. The gap-segment second derivative serves the purpose of providing a stable baseline to measure to, sharpens bands and helps separate any overlapping bands, which minimizes the spectral interferences that can arise from miscibility of the fluid sample with the solvent used in preparing the reagent. Alternatively, other suitable spectral processing can be used. It may be noted that the spectral values output by block 535 may not be in absorbance units but in arbitrary units, which are referred to as absorption measurements herein. It may also be noted that these measurements are not referenced to a spectral baseline point, because baseline offsets and tilts are not significant in second derivative spectra.

In block 537, the computer 180 utilizes the absorbance measurements of the final spectrum of block 535 for the spectral band around 2330 cm⁻¹ and 2340 cm⁻¹ (preferably at or near 2335 cm⁻¹) as input to the calibration equation of block 519 to calculate Unit Moisture (in μg/g) of the extract-reagent mixture. Note that Unit Moisture represents the concentration of moisture in the sample of interest. Importantly, the calibration equation relating Unit Moisture to absorbance for the particular spectral band(s) is universal in that it is independent of the sample weight or reagent volume used in the analysis of samples. Note that the moisture (water content) of the extract component of the extract-reagent mixture reacts with reagent component of the extract-reagent mixture to produce carbon dioxide gas (CO₂). With the reaction carried out in an sealed vessel (septum-capped vial), the carbon dioxide gas can be readily contained and subjected to FTIR spectroscopic analysis carried out by the spectrometer 110. The absorbance in the spectral band around 2330 cm⁻¹ and 2340 cm⁻¹ (preferably at or near 2335 cm⁻¹) is characteristic of the amount of carbon dioxide gas produced by this reaction due to the fact that the carbon dioxide gas is a strong infrared absorber and absorbs in this spectral band where few other functional groups absorbs. Thus, the spectral band around 2330 cm⁻¹ and 2340 cm⁻¹ (preferably at or near 2335 cm⁻¹) is largely free of spectral interferences in terms of the quantification of carbon dioxide gas that results from the reaction in the enclosed vessel.

In block 539, computer 180 converts the Unit Moisture (in μg/g) of the extract-reagent mixture of block 537 to a measure of moisture content (preferably in ppm) in the sample of interest. This measure of moisture content represents the concentration of moisture in the sample of interest. The moisture content of the sample of interest can be stored by the computer 180 and output to the user as desired.

Blocks 521-539 can be performed by automated (or semi-automated) fluid handling and measuring equipment as is well known in the art. Parts of blocks 521-529 can also be performed by manual fluid handling and measuring operations as is well known in the art.

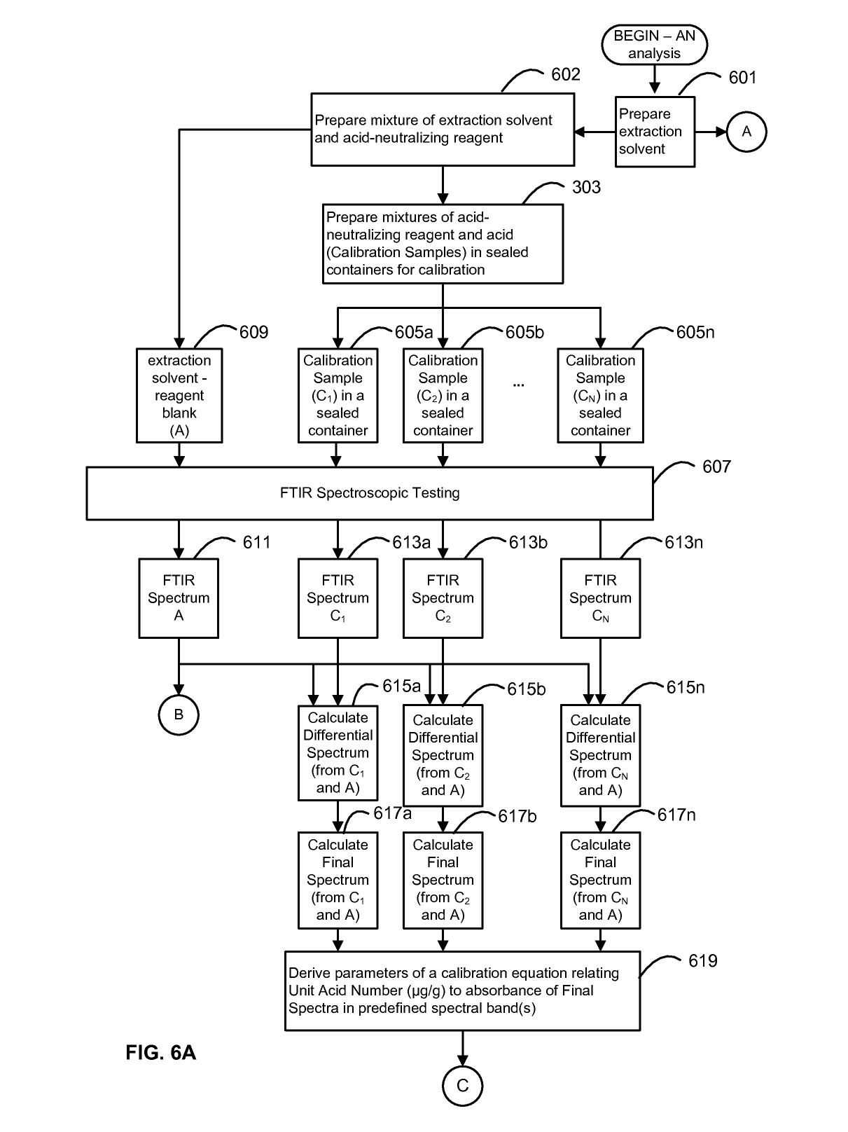

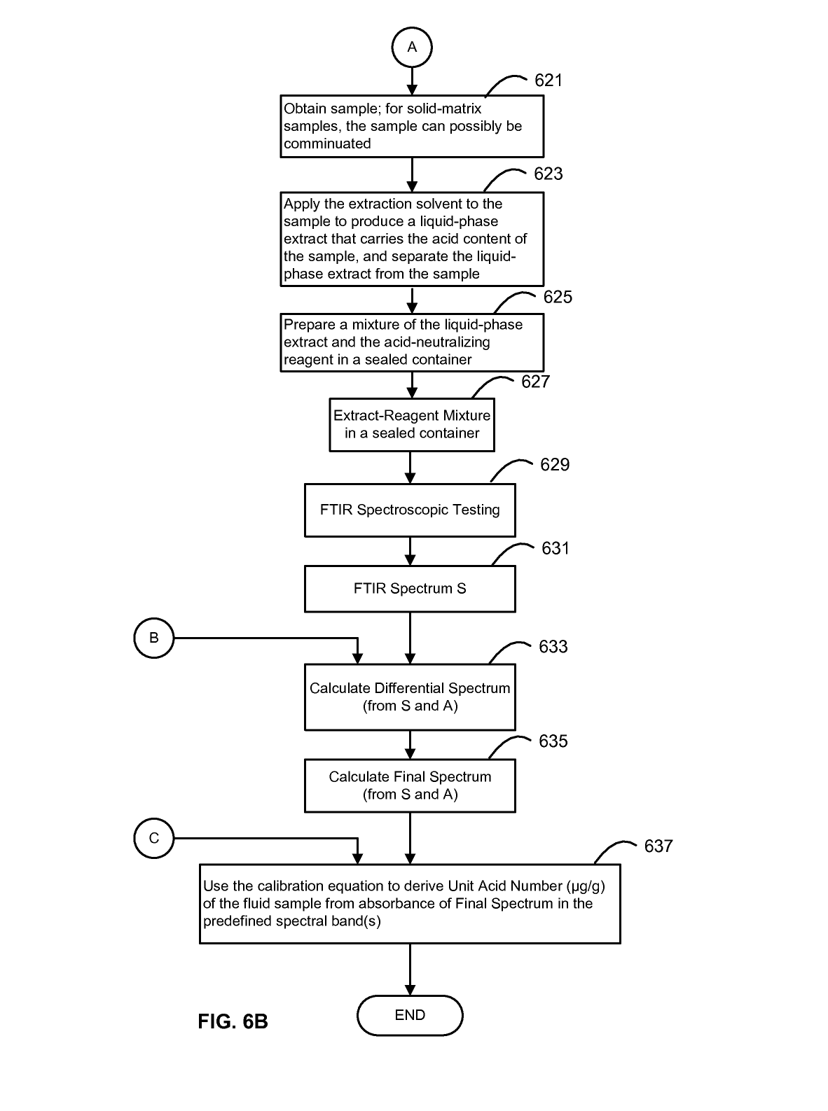

FIGS. 6A and 6B show a methodology similar to the methodology of FIGS. 3A and 3B, which is adapted to extract the acid content of a sample as part of a liquid-phase extract and react the acid content of the liquid-phase extract with a reagent that produces carbon dioxide gas at an amount that corresponds to the amount of the acid content in the sample. The amount of carbon dioxide gas can be measured by FTIR spectroscopy and input to a calibration equation to produce data (e.g., Unit Acid Number) that represents the relative concentration of the acid content in the sample. In this case, the extraction solvent can possibly be a suitable polar solvent that does not interfere with the strong IR absorption band of carbon dioxide in the spectral band around 2330 cm⁻¹ and 2340 cm⁻¹ (preferably at or near 2335 cm⁻¹).

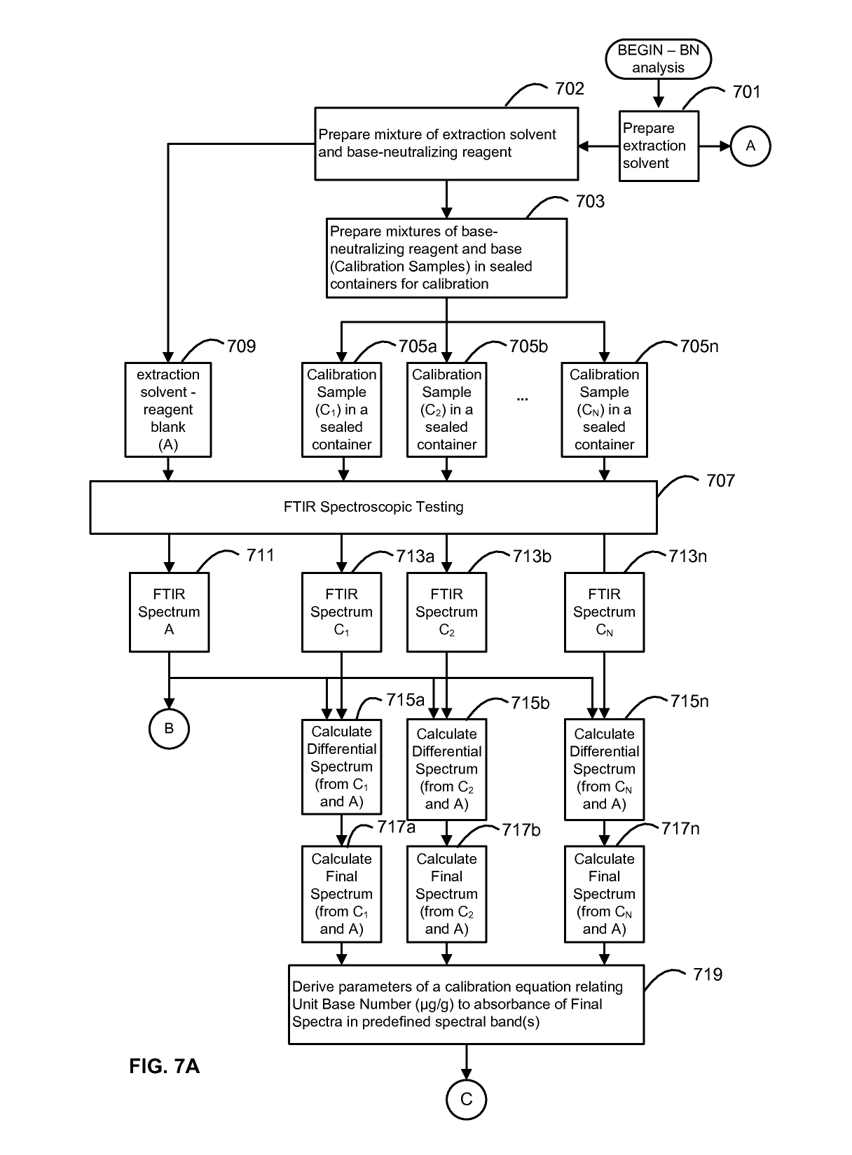

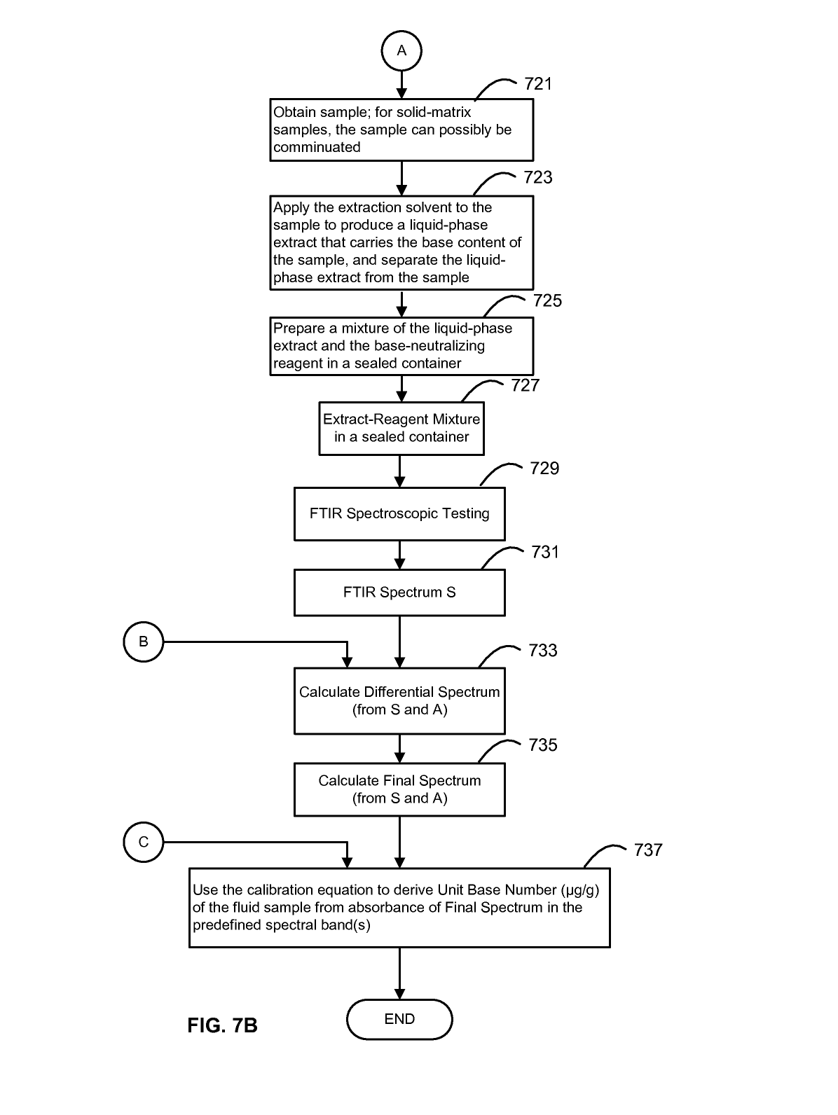

FIGS. 7A and 7B show a methodology similar to the methodology of FIGS. 4A and 4B, which is adapted to extract the base content of a sample as part of a liquid-phase extract and react the base content of the liquid-phase extract with a reagent that produces carbon dioxide gas at an amount that corresponds to the amount of the base content in the sample. The amount of carbon dioxide can be measured by FTIR spectroscopy and input to a calibration equation to produce data (e.g., Unit Base Number) that represents the relative concentration of the base content in the sample. In this case, the extraction solvent can possibly be a suitable polar solvent that does not interfere with the strong IR absorption band of carbon dioxide in the spectral band around 2330 cm⁻¹ and 2340 cm⁻¹ (preferably at or near 2335 cm⁻¹). The methodology is particularly suited to characterizing the concentration of carbonate base content in the sample.

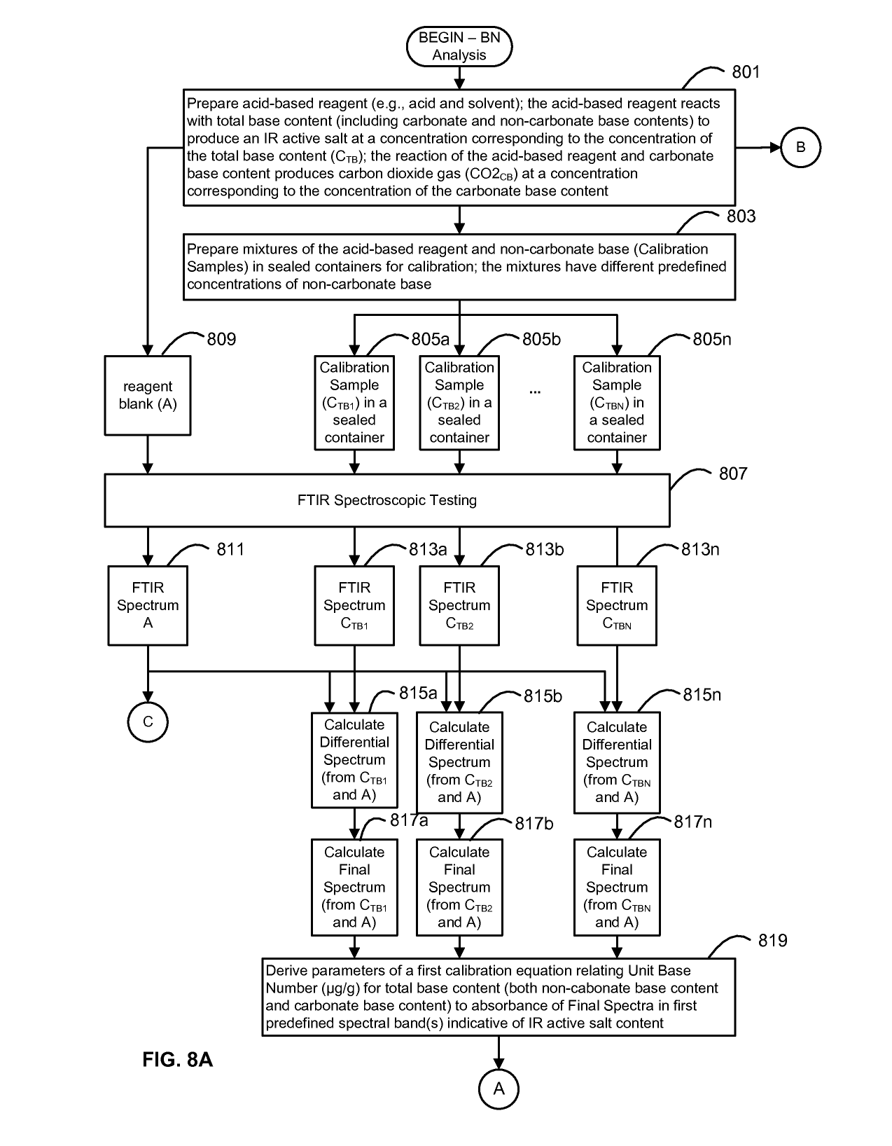

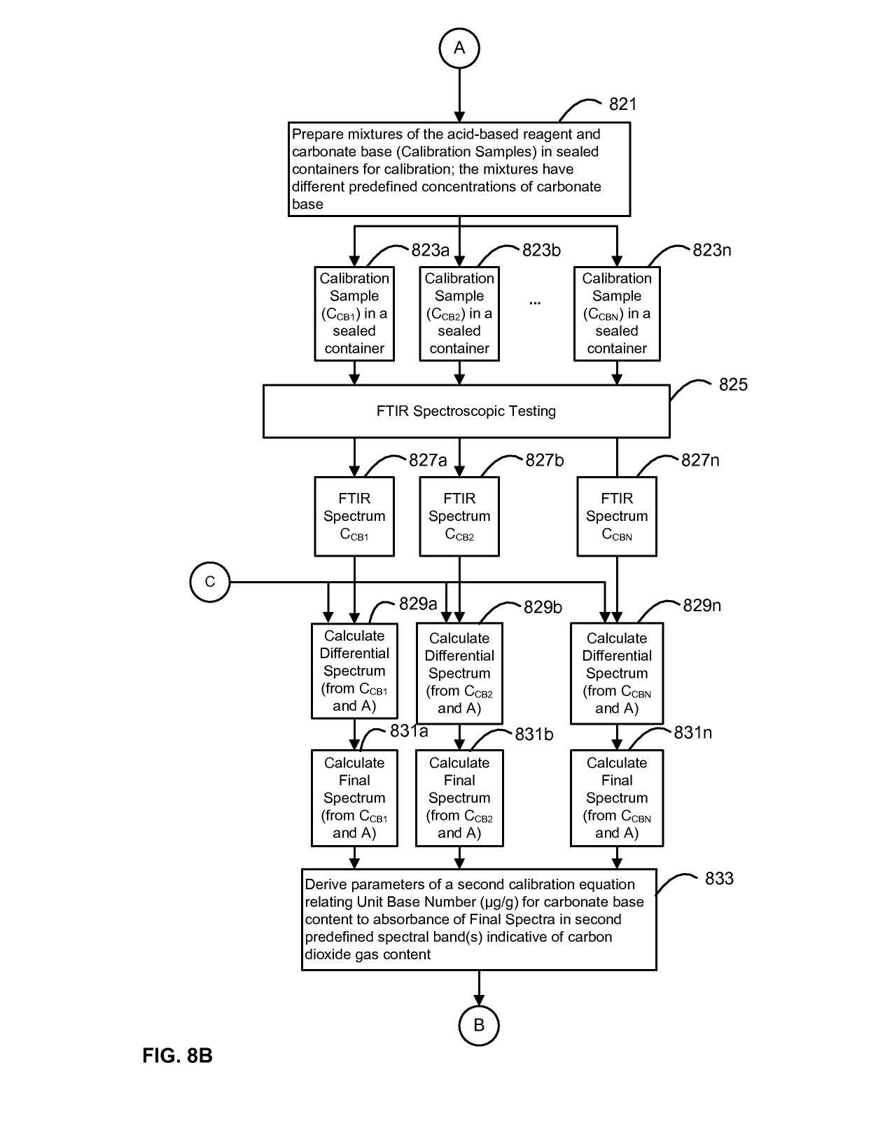

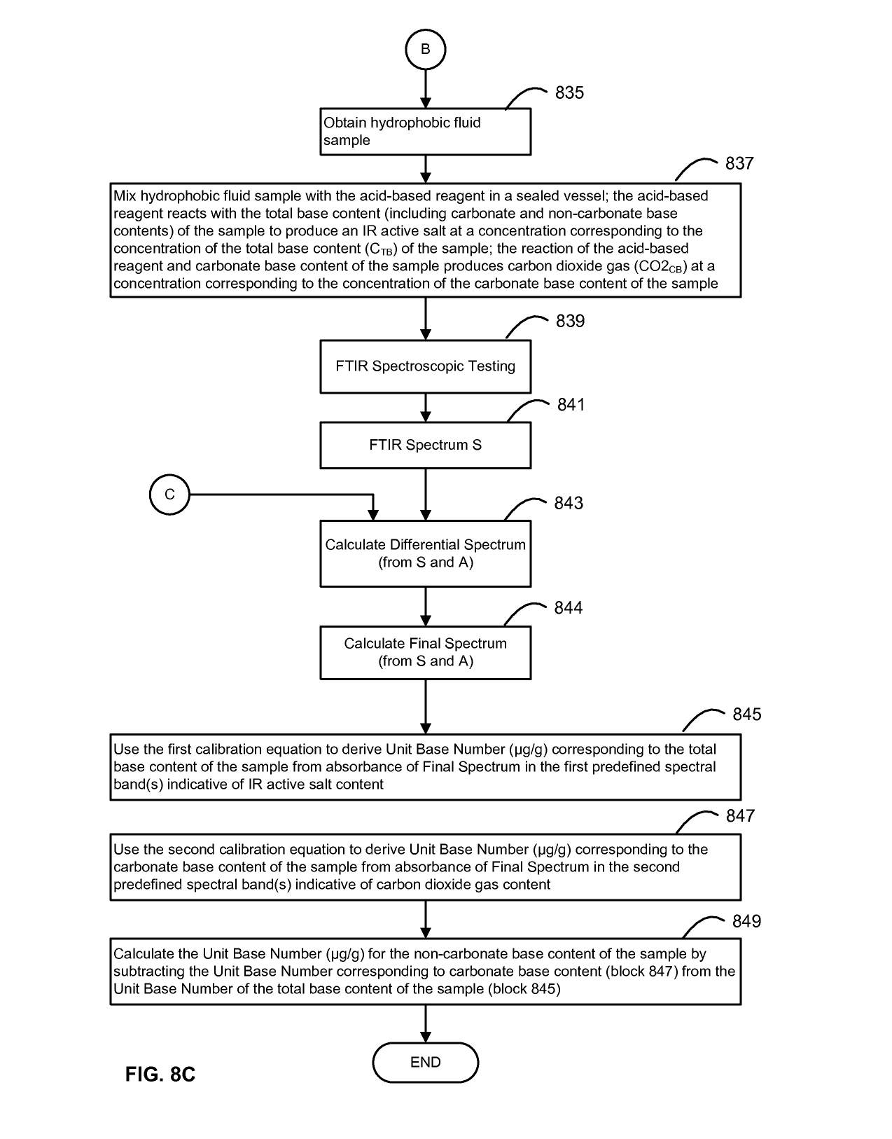

The system 100 of FIG. 1 can be used to perform the methodology of FIGS. 8A, 8B and 8C for generating data characterizing the basicity (concentration of base content) of a generally hydrophobic fluid sample in accordance with the present disclosure. The methodology is particularly suited to characterizing the concentration of total base content (including the concentration of carbonate base content and the concentration of non-carbonate base content) in the generally hydrophobic fluid sample. The method begins at block 801 with the preparation of an acid-based reagent. In one embodiment, the acid-based reagent is realized from a mixture of an acid and an oil miscible solvent (such as dioxane, tetrahyrofuran, toluene, propanol, 2-propanol, butanol, t-butanol, acetonitrile and DMSO). The acid is chosen such that it reacts with total base content of the sample (including both carbonate base content and non-carbonate base content of the sample) to produce an IR active salt at a concentration corresponding to the concentration of the total base content (labeled C_{TB}) in the sample. The acid is also chosen such that is reacts with the carbonate base content of the sample to produce carbon dioxide gas (labeled CO2_{CB}) at a concentration corresponding to the concentration of carbonate base content in the sample.

In one embodiment, the acid of the reagent of block 801 is trifluoroacetic acid (TFA, C₂HF₃O₂). In this case, trifluoroacetate anions are formed from the reaction of the TFA and the total base content of a sample, where the concentration of the resultant trifluoroacetate anions corresponds to the concentration of the total base content of the sample. The trifluoroacetate anions are an IR active salt that absorbs in the spectral range between 1666 cm⁻¹ and 1686 cm⁻¹ (preferably at or near 1676 cm⁻¹). Thus, the concentration of the trifluoroacetate anions (which corresponds to total base content) can be measured by IR spectroscopic analysis of this spectral range. Furthermore, with the reaction carried out in a sealed vessel, carbon dioxide gas (labeled CO2_{CB}) is formed from the reaction of the TFA and the carbonate base content of the sample, where the concentration of the resultant carbon dioxide gas corresponds to the concentration of the carbonate base content of the sample. The carbon dioxide gas absorbs in the spectral range around 2330 cm⁻¹ and 2340 cm⁻¹ (preferably at or near 2335 cm⁻¹). Thus, the concentration of the carbon dioxide gas (which corresponds to carbonate base content) can be measured by IR spectroscopic analysis of these spectral range(s).

Note that the acid and solvent components of the acid-based reagent of block 801 are chosen such that these components do not absorb in the same IR band as i) the spectral band(s) for the IR active salt (e.g., the spectral range between 1666 cm⁻¹ and 1686 cm⁻¹ (preferably at or near 1676 cm⁻¹) for the trifluoroacetate anions), and ii) the spectral bands) for the carbon dioxide gas (e.g., the spectral band around 2330 cm⁻¹ and 2340 cm⁻¹ (preferably at or near 2335 cm⁻¹).

At block 803, the acid-based reagent of block 801 is mixed with a non-carbonate base (such 1-methylimidazole or C₄H₆N₂) to produce a number of reagent-base mixtures (referred to herein as “calibration samples”) at different concentrations of the non-carbonate base for calibration purposes in measuring total base content. The n number of calibration samples are referred to as “C_{TB1}, C_{TB2}, . . . C_{TBN}” and labeled 805A, 805B . . . 805N in FIG. 8A. The non-carbonate base of the calibration samples C_{TB1} . . . C_{TBN} is chosen such that it does not absorb in the same IR band as the spectral band(s) for the IR active salt (e.g., the spectral range between 1666 cm⁻¹ and 1686 cm⁻¹ (preferably at or near 1676 cm⁻¹) for the trifluoroacetate anions). The calibration samples C_{TB1} . . . C_{TBN} can be stored in vessels (e.g., sealed vials).

The acid-based reagent of block 801 is also used to produce a reagent blank (labeled 809). In an illustrative embodiment, the reagent blank 809 is prepared by adding a predetermined quantity of the acid-based reagent of block 801 to a vessel (e.g., a sealed vial).

In block 807, the spectrometer 110 is configured to perform FTIR spectroscopic analysis on the reagent blank 809 (labeled A) as well as on each one of the calibration samples C_{TB1}, C_{TB2}, . . . C_{TBN}. The FTIR spectroscopic analysis of the calibration samples C_{TB1}, C_{TB2}, . . . C_{TBN} is performed after completion of the reaction of the acid and non-carbonate base content that produces the IR active salt in the respective vessels. The FTIR spectroscopic analysis of the reagent blank 809 produces an FTIR spectrum A (labeled 811) at the computer 180. The FTIR spectroscopic testing of the calibration sample C_{TB1} produces an FTIR spectrum C_{TB1} (labeled 813A) at the computer 180. The FTIR spectroscopic testing of the calibration sample C_{TB2} produces an FTIR spectrum C_{TB2} (labeled 813B) at the computer 180. FTIR spectra are generated for all of the remaining calibration samples C_{TB3} . . . C_{TBN}.

In the preferred embodiment, a set-up procedure is performed as part of the analysis of the reagent blank and each calibration sample. The set-up procedure typically involves cleaning the sample cell of the spectrometer 110 (for example, by washing with a solvent and drying by forcing air through the sample cell), performing a background scan on the spectrometer 110, loading the fluid sample from the sealed vessel into the sample cell of the spectrometer 110, and configuring the operating parameters for the spectrometer 110 and computer 180. The loading of fluid from the sealed vessel into the sample cell of the spectrometer 110 can employ a double pipette arrangement. The double pipette arrangement includes a supply-side pipette that supplies inert gas under pressure into the sealed vessel to displace the fluid contained in the sealed vessel out a discharge-side pipette to the sample cell of the spectrometer. Examples of double pipette arrangements are disclosed in PCT/IB96/0084 and incorporated herein by reference in its entirety. Alternatively, the inert gas can manually pumped through the supply-side pipette to displace the fluid contained in the sealed vessel out a discharge-side pipette to the sample cell of the spectrometer. In the configuration, the flow line leading to the supply-side pipette (or the inlet of the supply-side pipette itself) can employ a check-valve that limits any backflow of fluid from the sealed vessel out the supply-side pipette during the manual pumping process. After the set-up procedure is complete, the spectrometer 110 and computer 180 are operated to perform the experiment, collect the IR absorption data resulting from the experiment, and perform Fourier Transform processing on the collected IR absorption data to generate the FTIR spectrum for the respective sample.

In block 815A, the computer 180 calculates a differential spectrum for the calibration sample C_{TB1} from the FTIR spectrum C_{TB1} (labeled 813A) and the FTIR spectrum A (labeled 811). In block 815B, the computer 180 calculates a differential spectrum for the calibration sample C_{TB2} from the FTIR spectrum C_{TB2} (labeled 813B) and the FTIR spectrum A (labeled 811). Similar operations are performed by the computer 180 in blocks 815C . . . 815N to calculate differential spectra for the calibration samples C_{TB3} . . . C_{TBN}. The processing that calculates the differential spectra can apply correction factors (or other compensation factors) to the measured FTIR spectra for the respective calibration samples C_{TB1} . . . C_{TBN} to derive corrected spectra, and the FTIR spectrum A can be subtracted from the respective corrected spectra to calculate the differential spectra for the calibration samples C_{TB1} . . . C_{TBN}. Alternatively, other suitable spectral processing can be used.

In block 817A, the computer 180 processes the differential spectrum of block 815A to calculate a final spectrum for the calibration sample C_{TB1}. In block 817B, the computer 180 processes the differential spectrum of block 815B to calculate a final spectrum for the calibration sample C_{TB2}. Similar operations are performed by the computer 180 in blocks 817C . . . 817N to calculate final spectra for the calibration samples C_{TB3} . . . C_{TBN}. In the preferred embodiment, the final spectrum for the respective calibration sample is derived by taking 5-5 (gap segment) second derivative of the corresponding differential spectrum and multiplying the resultant second derivative by 100. The gap-segment second derivative serves the purpose of providing a stable baseline to measure to, sharpens bands and helps separate any overlapping bands, which minimizes spectral interferences.

In block 819, the computer 180 utilizes the absorbance measurements of the final spectra derived in blocks 817A, 817B . . . 817N in the spectral band(s) for the IR active salt (e.g., the spectral range between 1666 cm⁻¹ and 1686 cm⁻¹ (preferably at or near 1676 cm⁻¹) for the trifluoroacetate anions) to derive parameters of a first calibration equation relating Unit Base Number (in μg/g) for total base content (including both non-carbonate base content and carbonate base content) to absorbance of the final spectrum in such spectral band(s).

Note that the acid-based reagent of the calibration samples C_{TB1} . . . C_{TBN} reacts with the non-carbonate base content of the calibration samples C_{TB1} . . . C_{TBN} to produce the IR active salt (e.g., trifluoroacetate anions). With the reaction carried out in a sealed vessel (septum-capped vial), the IR active salt can be readily contained and subjected to FTIR spectroscopic analysis carried out by the spectrometer 110 in order to characterize the concentration of the IR active salt. For example, absorbance in the spectral band between 1666 cm⁻¹ and 1686 cm⁻¹ (preferably at or near 1676 cm⁻¹) is characteristic of the amount of trifluoroacetate anions produced by this reaction due to the fact that the trifluoroacetate anion is a strong infrared absorber and absorbs in this spectral band and is readily measured.

The computer 180 can carry out linear regression on the Unit Base Number for the calibration mixtures and the absorbance of the final spectra derived in blocks 817A, 817B . . . 817N for the spectral band around 1666 cm⁻¹ and 1686 cm⁻¹ (preferably at or near 1676 cm⁻¹) to obtain the parameters (a, b) of a best fit equation of the form:

Unit Base Number(in μg/g)=a+b*Abs(1676 cm⁻¹). (10)

Importantly, the calibration equation (10) relating Unit Base Number to absorbance for the particular spectral band is universal in that it is independent of the reagent volume used in the analysis.

At block 821, the acid-based reagent of block 801 is mixed with a carbonate base (such as NaHCO₃, KHCO₃, CaCO₃ and MgCO₃) to produce a number of reagent-base mixtures (referred to herein as “calibration samples”) at different predefined concentrations of the carbonate base for calibration purposes in measuring carbonate base content. The n number of calibration samples are referred to as “C_{CB1}, C_{CB2}, . . . C_{CBN}” and labeled 823A, 823B . . . 823N in FIG. 8B. The carbonate base of the calibration samples C_{CB1} . . . C_{CBN} is chosen such that it does not absorb in the same IR band as the spectral band(s) for carbon dioxide gas (e.g., the spectral band around 2330 cm⁻¹ and 2340 cm⁻¹ (preferably at or near 2335 cm⁻¹)). The calibration samples C_{CB1} . . . C_{CBN} can be stored in sealed vials that prevent the ingress of atmospheric carbon dioxide and the egress of carbon dioxide produced by the reaction of the base content with the base-neutralizing reagent of the calibration samples C_{CB1} . . . C_{CBN}. The headspace volumes of the sealed vessels can be controlled to provide low volume headspaces that minimizes carbon dioxide in such headspaces when loading the sealed vessels, which facilitates a quantitative measure of carbon dioxide gas in solution that is produced by the reaction of the acid and base content of the calibration samples C_{CB1} . . . C_{CBN}.

In block 825, the spectrometer 110 is configured to perform FTIR spectroscopic analysis on each one of the calibration samples C_{CB1}, C_{CB2}, . . . C_{CBN}. The FTIR spectroscopic analysis of the calibration samples C_{CB1}, C_{CB2}, . . . C_{CBN} is performed after completion of the reaction of the acid and carbonate base content that produces carbon dioxide gas in the respective vessels. The FTIR spectroscopic testing of the calibration sample C_{CB1} produces an FTIR spectrum C_{CB1} (labeled 827A) at the computer 180. The FTIR spectroscopic testing of the calibration sample C_{CB2} produces an FTIR spectrum C_{CB2} (labeled 827B) at the computer 180. FTIR spectra are generated for all of the remaining calibration samples C_{CB3} . . . C_{CBN}.

In the preferred embodiment, a set-up procedure is performed as part of the analysis of each calibration sample. The set-up procedure typically involves cleaning the sample cell of the spectrometer 110 (for example, by washing with a solvent and drying by forcing air through the sample cell), performing a background scan on the spectrometer 110, loading the fluid sample from the sealed vessel into the sample cell of the spectrometer 110, and configuring the operating parameters for the spectrometer 110 and computer 180. The loading of fluid from the sealed vessel into the sample cell of the spectrometer 110 can employ a double pipette arrangement. The double pipette arrangement includes a supply-side pipette that supplies inert gas under pressure into the sealed vessel to displace the fluid contained in the sealed vessel out a discharge-side pipette to the sample cell of the spectrometer. Examples of double pipette arrangements are disclosed in PCT/IB96/0084 and incorporated herein by reference in its entirety. Alternatively, the inert gas can manually pumped through the supply-side pipette to displace the fluid contained in the sealed vessel out a discharge-side pipette to the sample cell of the spectrometer. In the configuration, the flow line leading to the supply-side pipette (or the inlet of the supply-side pipette itself) can employ a check-valve that limits any backflow of carbon dioxide gas (or other fluid) from the sealed vessel out the supply-side pipette during the manual pumping process. After the set-up procedure is complete, the spectrometer 110 and computer 180 are operated to perform the experiment, collect the IR absorption data resulting from the experiment, and perform Fourier Transform processing on the collected IR absorption data to generate the FTIR spectrum for the respective sample.

In block 829A, the computer 180 calculates a differential spectrum for the calibration sample C_{CB1} from the FTIR spectrum C_{CB1} (labeled 827A) and the FTIR spectrum A (labeled 811). In block 829B, the computer 180 calculates a differential spectrum for the calibration sample C_{CB2} from the FTIR spectrum C_{CB2} (labeled 827B) and the FTIR spectrum A (labeled 811). Similar operations are performed by the computer 180 in blocks 829C . . . 829N to calculate differential spectra for the calibration samples C_{CB3} . . . C_{CBN}. The processing that calculates the differential spectra can apply correction factors (or other compensation factors) to the measured FTIR spectra for the respective calibration samples C_{CB1} . . . C_{CBN} to derive corrected spectra, and the FTIR spectrum A can be subtracted from the respective corrected spectra to calculate the differential spectra for the calibration samples C_{CB1} . . . C_{CBN}. Alternatively, other suitable spectral processing can be used.

In block 831A, the computer 180 processes the differential spectrum of block 829A to calculate a final spectrum for the calibration sample C_{CB1}. In block 831B, the computer 180 processes the differential spectrum of block 829B to calculate a final spectrum for the calibration sample C_{CB2}. Similar operations are performed by the computer 180 in blocks 831C . . . 831N to calculate final spectra for the calibration samples C_{CB3} . . . C_{CBN}. In the preferred embodiment, the final spectrum for the respective calibration sample is derived by taking 5-5 (gap segment) second derivative of the corresponding differential spectrum and multiplying the resultant second derivative by 100. The gap-segment second derivative serves the purpose of providing a stable baseline to measure to, sharpens bands and helps separate any overlapping bands, which minimizes spectral interferences.

In block 833, the computer 180 utilizes the absorbance measurements of the final spectra derived in blocks 831A, 831B . . . 831N in the spectral band(s) for carbon dioxide gas (e.g., the spectral band around 2330 cm⁻¹ and 2340 cm⁻¹ (preferably at or near 2335 cm⁻¹) to derive parameters of a second calibration equation relating Unit Base Number (in μg/g) for carbonate base content to absorbance of the final spectrum in such spectral band(s).

Note that the acid-based reagent of the calibration samples C_{CB1} . . . C_{CBN} reacts with the carbonate base content of the calibration samples C_{CB1} . . . C_{CBN} to produce carbon dioxide gas. With the reaction carried out in a sealed vessel (septum-capped vial), the carbon dioxide gas can be readily contained and subjected to FTIR spectroscopic analysis carried out by the spectrometer 110 in order to characterize the concentration of the carbon dioxide gas. Absorbance in the spectral band around 2330 cm⁻¹ and 2340 cm⁻¹ (preferably at or near 2335 cm⁻¹) is characteristic of the amount of carbon dioxide gas produced by this reaction due to the fact that the carbon dioxide gas is a strong infrared absorber and absorbs in this spectral band where few other functional groups absorbs. Thus, the spectral band around 2330 cm⁻¹ and 2340 cm⁻¹ (preferably at or near 2335 cm⁻¹) is largely free of spectral interferences in terms of the quantification of carbon dioxide gas that results from the reaction in the enclosed vessel.

The computer 180 can carry out linear regression on the Unit Base Number for the calibration mixtures and the absorbance of the final spectra derived in blocks 831A, 831B . . . 831N for the spectral band around 2330 cm⁻¹ and 2340 cm⁻¹ (preferably at or near 2335 cm⁻¹) to obtain the parameters (a, b) of a best fit equation of the form:

Unit Base Number(in μg/g)=a+b*Abs(2335 cm⁻¹). (11)

Importantly, the calibration equation (11) relating Unit Base Number to absorbance for the particular spectral band is universal in that it is independent of the reagent volume used in the analysis.

In block 835, a generally hydrophobic fluid sample is obtained. The hydrophobic fluid sample can be a lubricant, edible oil, transformer oil or a fuel such as biodiesel.

In block 837, at least a portion of the hydrophobic fluid sample of block 835 is mixed the acid-based reagent of block 801 in a sealed vial. The amount of the acid-based reagent in the mixture is controlled such that its acid content exceeds the amount of acid that is neutralized by the total base content (including both non-carbonate base content and carbonate base content) of the sample. The acid of the reagent reacts with total base content of the sample (including both carbonate base content and non-carbonate base content of the sample) to produce an IR active salt at a concentration corresponding to the concentration of the total base content in the sample. The acid of the reagent also reacts with the carbonate base content of the sample to produce carbon dioxide gas (labeled CO2_{CB}) at a concentration corresponding to the concentration of carbonate base content in the sample. The weight (in grams) of the hydrophobic fluid sample in the mixture is measured and recorded by the computer 180. The volume (in mL) of the acid-based reagent in mixture is also measured and recorded by the computer 180. The headspace volume of the sealed vessel can be controlled to provide low volume headspace that minimizes carbon dioxide in such headspace when loading the sealed vessel, which facilitates a quantitative measure of carbon dioxide gas in solution that is produced by the reaction of the acid-based reagent and carbonate base content of the sample as contained in the sample-reagent mixture. The mixture can be mixed (for example, by mixing the sealed vessel in a vortex mixer or by agitating the sealed vessel in a sonicating water bath) at a predetermined temperature for a predetermined period of time in order to enhance the reactions of the mixture.

In block 839, the spectrometer 110 is configured to perform FTIR spectroscopic analysis on resultant mixture to produce an FTIR spectrum S (labeled 841).

In the preferred embodiment, a set-up procedure is performed as part of the analysis of the sample-reagent mixture. The set-up procedure typically involves cleaning the sample cell of the spectrometer 110 (for example, by washing with a solvent and drying by forcing air through the sample cell), performing a background scan on the spectrometer 110, loading the sample-reagent mixture from the sealed vessel into the sample cell of the spectrometer 110, and configuring the operating parameters for the spectrometer 110 and computer 180. The loading of the sample-reagent mixture from the sealed vessel into the sample cell of the spectrometer 110 can employ a double pipette arrangement. The double pipette arrangement includes a supply-side pipette that supplies inert gas under pressure into the sealed vessel to displace the fluid contained in the sealed vessel out a discharge-side pipette to the sample cell of the spectrometer. Examples of double pipette arrangements are disclosed in PCT/IB96/0084 and incorporated herein by reference in its entirety. Alternatively, the inert gas can manually pumped through the supply-side pipette to displace the fluid contained in the sealed vessel out a discharge-side pipette to the sample cell of the spectrometer. In the configuration, the flow line leading to the supply-side pipette (or the inlet of the supply-side pipette itself) can employ a check-valve that limits any backflow of carbon dioxide gas (or other fluid) from the sealed vessel out the supply-side pipette during the manual pumping process. After the set-up procedure is complete, the spectrometer 110 and computer 180 are operated to perform the experiment, collect the IR absorption data resulting from the experiment, and perform Fourier Transform processing on the collected IR absorption data to generate the FTIR spectrum for the resultant mixture.

In block 843, the computer 180 calculates a differential spectrum for the resultant mixture from the FTIR spectrum S (labeled 841) and the FTIR spectrum A (labeled 811). The processing that calculates the differential spectrum can apply a correction factor (or other compensation factor) to the measured FTIR spectrum S to derive a corrected spectrum, and the FTIR spectrum A can be subtracted from the corrected spectrum to calculate the differential spectrum for the resultant mixture. Alternatively, other suitable spectral processing can be used.

In block 844, the computer 180 processes the differential spectrum for the resultant mixture of block 843 to calculate a final spectrum for the resultant mixture. In the preferred embodiment, the final spectrum for the resultant mixture is derived by taking 5-5 (gap segment) second derivative of the corresponding differential spectrum as described above. The gap-segment second derivative serves the purpose of providing a stable baseline to measure to, sharpens bands and helps separate any overlapping bands, which minimizes the spectral interferences that can arise from miscibility of the fluid sample with the solvent used in preparing the acid-based reagent. Alternatively, other suitable spectral processing can be used. It may be noted that the spectral values output by block 844 may not be in absorbance units but are referred to as absorption measurements herein. It may also be noted that these measurements are not referenced to a spectral baseline point, because baseline offsets and tilts are not significant in second derivative spectra.

In block 845, the computer 180 utilizes the absorbance measurements of the final spectrum of block 844 in the spectral band(s) for the IR active salt (e.g., the spectral range between 1666 cm⁻¹ and 1686 cm⁻¹ (preferably at or near 1676 cm⁻¹) for the trifluoroacetate anions) as input to the first calibration equation of block 819 to calculate Unit Base Number (in μg/g) of the sample. This Unit Base Number characterizes the concentration of the total base content (including both non-carbonate base content and carbonate base content) in the sample. Importantly, the first calibration equation relating Unit Base Number to absorbance for the particular spectral band(s) is universal in that it is independent of the sample weight or reagent volume used in the analysis of samples.

In block 847, the computer 180 utilizes the absorbance measurements of the final spectrum of block 844 for the spectral band(s) of carbon dioxide base (e.g., the spectral band around 2330 cm⁻¹ and 2340 cm⁻¹ (preferably at or near 2335 cm⁻¹)) as input to the second calibration equation of block 833 to calculate Unit Base Number (in μg/g) of the resultant mixture. This Unit Base Number characterizes the concentration of the carbonate base content in the sample. Importantly, the second calibration equation relating Unit Base Number to absorbance for the particular spectral band(s) is universal in that it is independent of the sample weight or reagent volume used in the analysis of samples.

In block 849, the Unit Base Number (m/g) for the non-carbonate base content of the sample is calculated by subtracting the Unit Base Number for the carbonate base content of the sample (block 847) from the Unit Base Number for the total base content of the sample (block 845).

The Unit Base Numbers of blocks 845, 847 and 849 can be stored by the computer 180 and output to the user as desired. These Unit Base Number (in μg/g) represents the basicity (concentration of certain base content components) of the fluid sample. Such basicity is conventionally measured by potentiometric titration by its stoichiometric reaction with a strong acid.

Blocks 835-849 can be performed by automated (or semi-automated) fluid handling and measuring equipment as is well known in the art. Parts of blocks 835-849 can also be performed by manual fluid handling and measuring operations as is well known in the art.

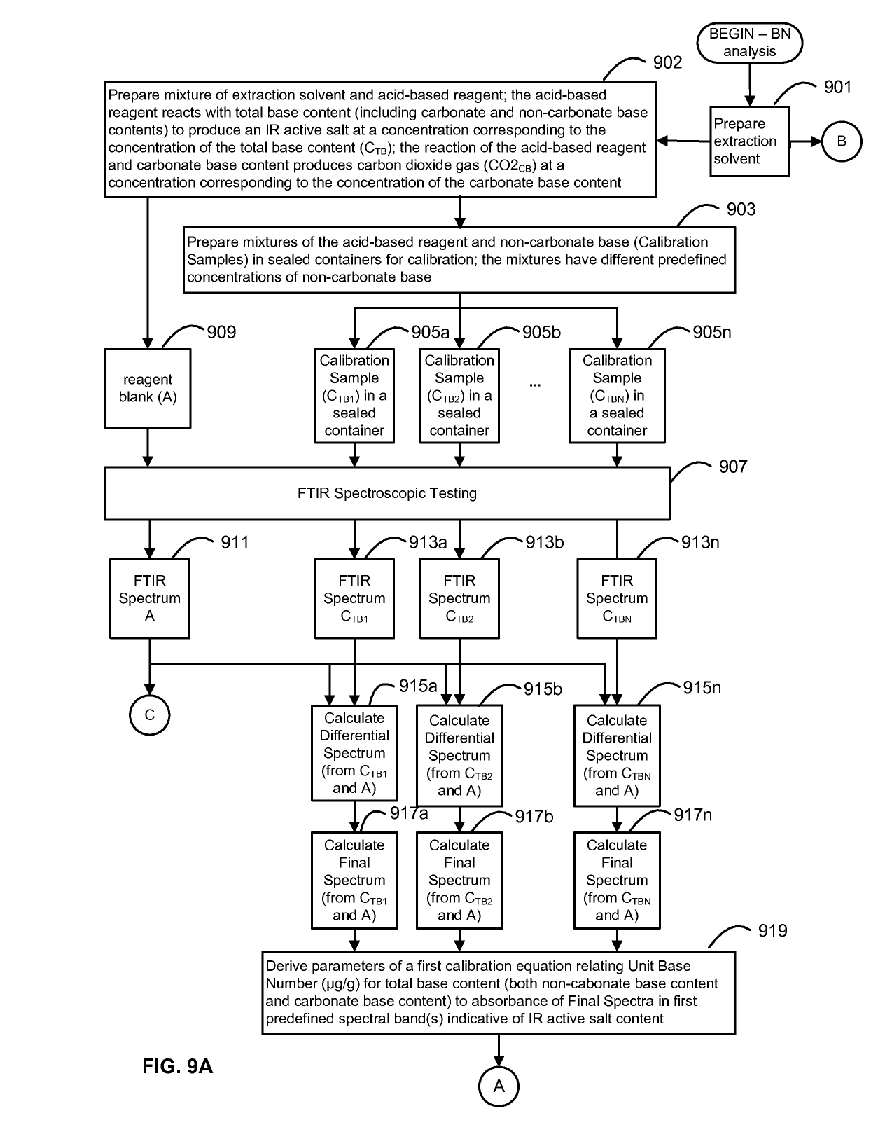

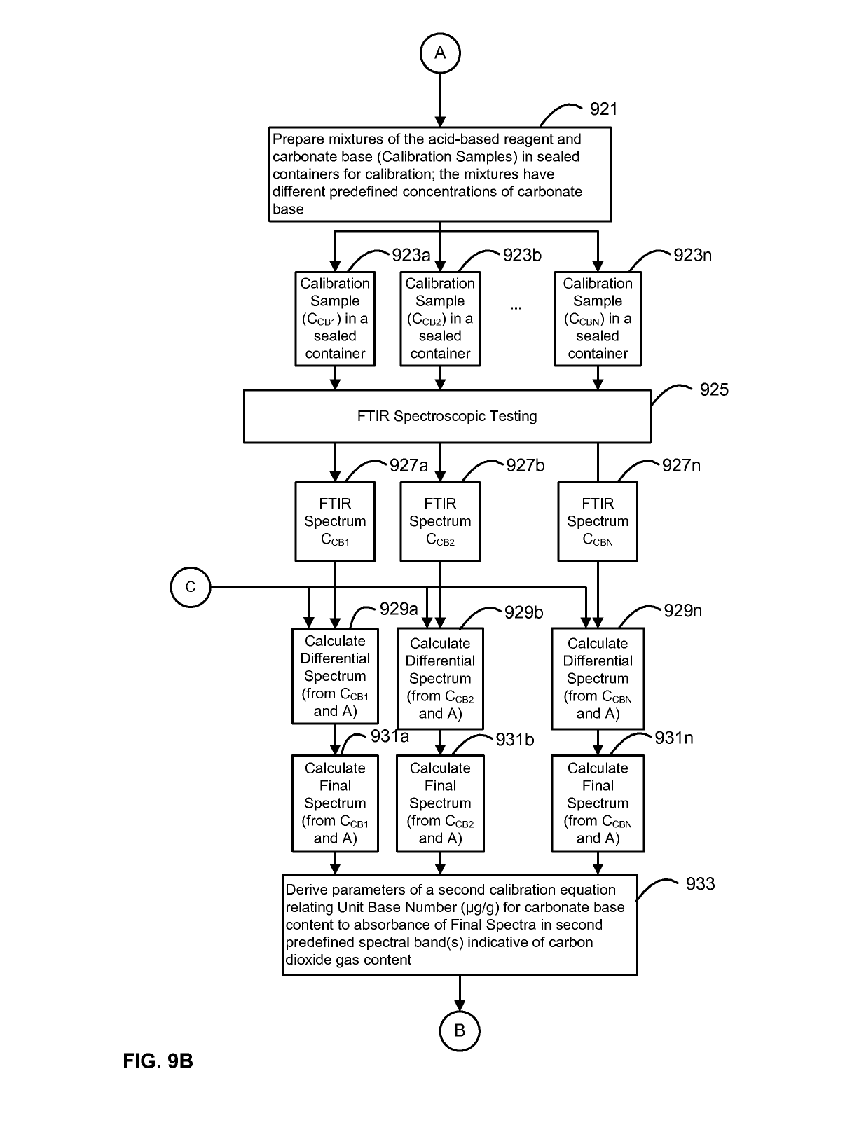

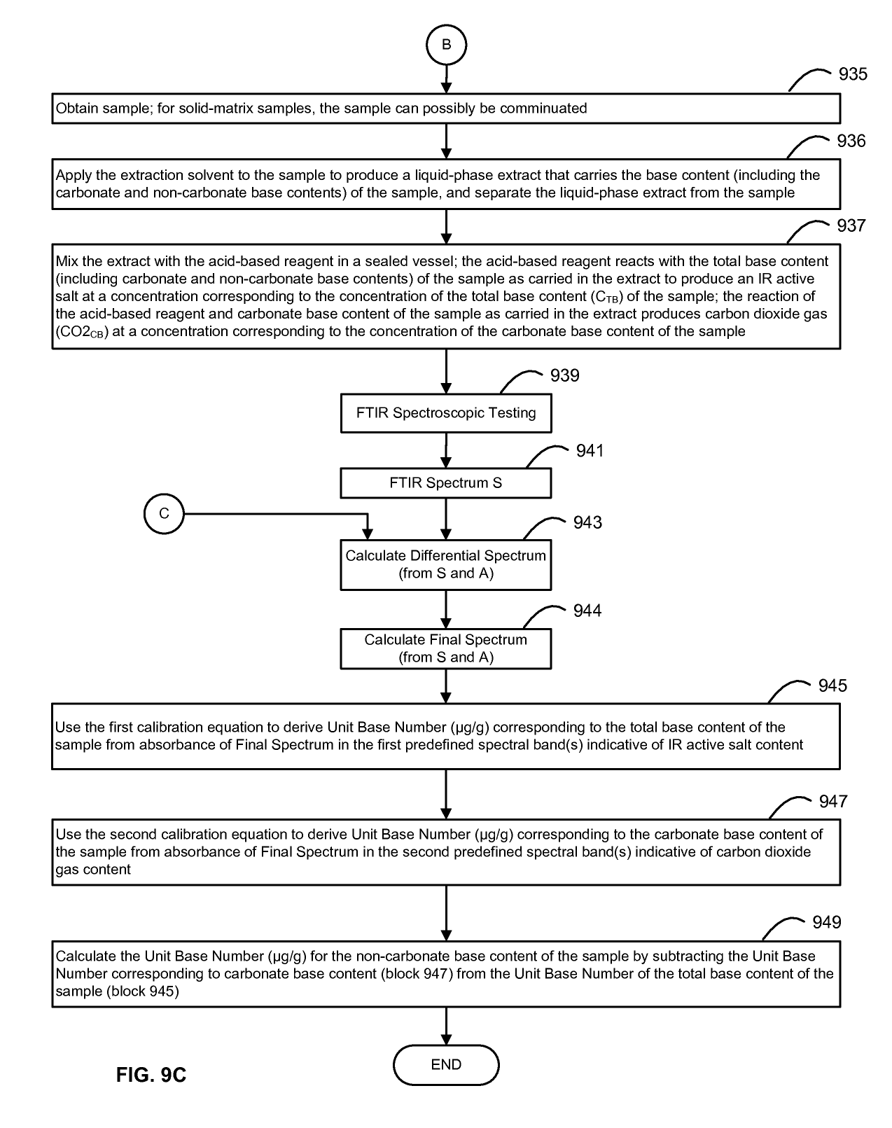

FIGS. 9A, 9B and 9C show a methodology similar to the methodology of FIGS. 8A, 8B and 8C, which is adapted to extract the base content of a sample as part of a liquid-phase extract and react the total base content (including both non-carbonate base content and carbonate base content) of the liquid-phase extract with an acid-based reagent that produces an IR active salt at an amount that corresponds to the amount of the total base content in the sample. The reaction of the carbonate base content of the liquid-phase extract with the acid-based reagent produces carbon dioxide gas at an amount that corresponds to the amount of the carbonate base content in the sample. The amount of IR active salt can be measured by FTIR spectroscopy and input to a first calibration equation to produce data (e.g., Unit Base Number) that represents the relative concentration of the total base content in the sample. The amount of carbon dioxide gas can be measured by FTIR spectroscopy and input to a second calibration equation to produce data (e.g., Unit Base Number) that represents the relative concentration of the carbonate base content in the sample. The relative concentration of the non-carbonate base content of the sample can be calculated by subtraction the Unit Base Number for the carbonate base content in the sample from the Unit Base Number for the total base content in the sample. In this case, the extraction solvent can possibly be a suitable polar solvent that does not interfere with the strong IR absorption band of the active IR salt and carbon dioxide. The methodology is particularly suited to characterizing the concentration of both non-carbonate base content and carbonate base content in the sample.

Note that chemometrics can be applied to the data representing the moisture content (e.g., Unit Moisture Number), the data representing acidity (e.g., Unit Acid Number), and/or the data representing basicity (e.g., Unit Base Number) of a sample as derived herein in order to generate results that match the results of standardized ASTM experiments.

Also note that spectral analysis of the FTIR spectrums as described herein that derive the respective calibration equations and resultant data characterizing moisture content, acidity and/or basicity can possibly be adapted to process other spectral bands that are characteristic of carbon dioxide gas concentration. One example of a possible spectral band is the spectral band that encompasses the range between 660 cm⁻¹ and 680 cm⁻¹ (preferably at or near 670 cm⁻¹).

The embodiments of the present application as described herein can provide many advantages as follows:
a single, common and unique component, carbon dioxide (CO₂), is measured to characterize moisture content, acid content and carbonate base content of the fluid sample;
a single, common data processing software package is required for all three methods;
issues related to spectral interferences and sample dilution are avoided to provide better accuracy and reproducibility;
the cell path lengths can be larger, making loading easier (500-1500 um) and further minimizing loading issues and analytical speed;
the fluid samples can possibly be diluted, dependent on application;
carbon dioxide has a strong IR absorption band (particularly around 2335 cm⁻¹) and is unique, and has few, if any spectral interferences;
simple Beers law applies and no advanced chemometrics are required to make spectral data concur with ASTM results for moisture and acid number;
the measurements of moisture content and acid number conform to standardized ASTM techniques; and
the same instrument configuration can be used for analyses of moisture content, acidity and/or basicity of a sample.

There have been described and illustrated herein several embodiments of a FTIR system and a method for compositional analysis (including measurement of moisture content, acid content and base content) of hydrophobic fluids. A single, common and unique component, carbon dioxide, is measured to characterize moisture content, acid content and carbonate base content of the fluid sample. While particular embodiments of the invention have been described, it is not intended that the invention be limited thereto, as it is intended that the invention be as broad in scope as the art will allow and that the specification be read likewise. Thus, while particular instruments and apparatuses have been disclosed, it will be appreciated that other instruments and apparatuses may be used as well, including various types of computers, spectroscopic analyzers, and manual or automated systems to conduct sample testing to control and/or monitor the quality of a fluid. In addition, while particular quantities and volumes of reagents and samples have been disclosed, it will be appreciated that other quantities and volumes of reagents and samples may be used. While particular method steps for procuring and testing samples have been disclosed, it will be appreciated that certain steps may be omitted from the method, and/or that other steps may be included in the method. Further, while a particular calibration process has been disclosed, it will be appreciated that other calibration processes and empirical modules relating measured absorption changes at the IR wavelengths related to base content or compensation for underlying absorptions may be utilized. While particular attributes of a sample have been measured and particular equations and calculations have been disclosed based on the measured attributes of the sample for calculating specific parameters of the sample, it will be appreciated that other equations may be utilized, other attributes may be measured, and other parameters may be calculated. It will therefore be appreciated by those skilled in the art that yet other modifications could be made to the provided invention without deviating from its spirit and scope as claimed.

What is claimed is:

1. A method for analysis of a predefined component of a sample, the method comprising:
i) preparing a number of standard mixtures in sealed vessels that include a reagent and a component part, wherein the reagent reacts with the component part of the standard mixtures to produce carbon dioxide gas in a manner analogous to reaction of the reagent and the predefined component of the sample, and wherein the number of standard mixtures have different concentrations of the component part;
ii) performing FTIR analysis on contents of the sealed vessels that hold that the standard mixtures to measure respective absorbances in a predefined spectral band characteristic of carbon dioxide gas concentration;
iii) using the respective absorbances measured in ii) to derive a calibration equation that relates concentration of the predefined component to absorbance in the predefined spectral band characteristic of carbon dioxide gas concentration;
iv) preparing a mixture stored in a sealed vessel that is derived from the sample and the reagent;
v) performing FTIR analysis on contents of the sealed vessel that holds the mixture of iv) to measure absorbance in the predefined spectral band characteristic of carbon dioxide gas concentration; and
vi) calculating data that characterizes concentration of the predefined component in the sample based on the absorbance measured in v) and the calibration equation derived in iii).

2. A method according to claim 1, wherein:
the sample is a hydrophobic fluid sample selected from the group consisting of lubricants, edible oils, and fuels; and/or
the sample comprises a solid matrix.

3. A method according to claim 1, further comprising:
vii) storing the data calculated in vi) for output.

4. A method according to claim 3, further comprising:
viii) outputting to a user the data stored in vii).

5. A method according to claim 1, wherein:
the predefined spectral band encompasses the range between 2330 cm⁻¹ and 2340 cm⁻¹.

6. A method according to claim 1, wherein:
the FTIR analysis of ii) includes the derivation of differential spectrum data for the number of standard mixtures of i), and processing the differential spectrum data for the number of standard mixtures of i) to derive final spectrum data for the number of standard mixtures of i); and
the FTIR analysis of v) includes the derivation of differential spectrum data for the mixture of iv), and processing the differential spectrum data for the mixture of iv) to derive final spectrum data for the mixture of iv).

7. A method according to claim 6, wherein:
the differential spectrum data of ii) and v) are based on a 5-5 (gap-segment) derivative of spectral data.

8. A method according to claim 6, wherein:
the differential spectrum data of ii) and v) are based on respective correction factors.

9. A method according to claim 1, wherein:
the mixture of iv) is prepared by reacting at least a portion of the sample with the reagent in a sealed vessel in order to produce an amount of carbon dioxide gas in the sealed vessel corresponding to the amount of the predefined component in the sample.

10. A method according to claim 1, wherein:
the mixture of iv) is prepared by applying an extraction solvent to the sample to produce a liquid-phase extract that carries the predefined component of the sample, and reacting the liquid-phase extract with the reagent in a sealed vessel in order to produce an amount of carbon dioxide gas in the sealed vessel corresponding to the amount of the predefined component in the sample.

11. A method according to claim 1, wherein:
the predefined component comprises moisture content of the sample.

12. A method according to claim 12, wherein:
the reagent includes p-toluenesulfonyl isocyanate (TSI) or other homologous isocyanate that reacts with moisture to produce carbon dioxide gas.

13. A method according to claim 12, wherein:
the sample is a hydrophobic fluid sample, and the reagent further includes an aprotic solvent that is miscible in the hydrophobic fluid sample.

14. A method according to claim 13, wherein:
the aprotic solvent is selected from the group consisting of toluene, tetrahydrofuran, and dioxane.

15. A method according to claim 11, wherein:
the component part of the standard mixtures includes water.

16. A method according to claim 15, wherein:
the standard mixtures further include dioxane as a diluent of the water.

17. A method according to claim 1, wherein:
the predefined component comprises acid content of the sample.

18. A method according to claim 17, wherein:
the reagent includes an alkali salt that reacts with acid content to produce carbon dioxide gas.

19. A method according to claim 18, wherein:
the alkali salt is selected from the group including sodium carbonate (Na₂CO₃) and potassium carbonate (K₂CO₃).

20. A method according to claim 18, wherein:
the sample is a hydrophobic fluid sample, and the reagent further includes water and an oil miscible solvent.

21. A method according to claim 20, wherein:
the oil miscible solvent is selected from the group consisting of dioxane, tetrahyrofuran, toluene, propanol, 2-propanol, butanol, t-butanol, acetonitrile and DMSO.

22. A method according to claim 18, wherein:
the component part of the standard mixtures includes an acid.

23. A method according to claim 22, wherein:
the acid is selected from the group consisting of HCl, perchloric acid, HBr, HF and sulfuric acid.

24. A method according to claim 1, wherein:
the predefined component comprises carbonic base content of the sample.

25. A method according to claim 24, wherein:
the carbonic base content of the sample comprises metal carbonates.

26. A method according to claim 24, wherein:
the reagent includes an acid that reacts with carbonic base content to produce carbon dioxide gas.

27. A method according to claim 26, wherein:
the acid is HCl.

28. A method according to claim 26, wherein:
the sample is a hydrophobic fluid sample, and the reagent further includes water and an oil miscible solvent.

29. A method according to claim 28, wherein:
the oil miscible solvent is selected from the group consisting of dioxane, tetrahyrofuran, toluene, propanol, 2-propanol, butanol, t-butanol, acetonitrile and DMSO.

30. A method according to claim 24, wherein:
the component part of the standard mixtures includes a base.

31. A method according to claim 30, wherein:
the base is a metal carbonate.

32. A method according to claim 31, wherein:
the metal carbonate is selected from the group including CaCO₃ and MgCO₃.

33. A method for analysis of total base content of a sample which includes both non-carbonic base content of the sample and carbonic base content of the sample, the method comprising:
i) preparing a first set of standard mixtures in sealed vessels that include a reagent and a first component part, wherein the reagent reacts with the first component part to produce an IR active salt in a manner analogous to reaction of the reagent and the total base content of the sample, and wherein the first set of standard mixtures have different concentrations of the first component part;
ii) performing FTIR analysis on contents of the sealed vessels that hold the first set of standard mixtures to measure respective absorbances in a predefined spectral band characteristic of IR active salt concentration;
iii) using the respective absorbances measured in ii) to derive a first calibration equation that relates concentration of total base content to absorbance in the predefined spectral band characteristic of IR active salt concentration;
iv) preparing a second set of standard mixtures in sealed vessels that include the reagent and a second component part, wherein the reagent reacts with the second component part to produce carbon dioxide gas in a manner analogous to reaction of the reagent and the carbonic base content of the sample, and wherein the second set of standard mixtures have different concentrations of the second component part;
v) performing FTIR analysis on contents of the sealed vessels that hold the second set of standard mixtures to measure respective absorbances in a predefined spectral band characteristic of carbon dioxide gas concentration;
vi) using the respective absorbances measured in v) to derive a second calibration equation that relates concentration of carbonate base content to absorbance in the predefined spectral band characteristic of carbon dioxide gas concentration;
vii) preparing a mixture stored in a sealed vessel that is derived from the sample and the reagent, wherein the reagent reacts with total base content to produce the IR active salt at a concentration corresponding to total base content in the sample, and wherein the reagent reacts with carbonic base content in the sample to produce carbon dioxide gas at a concentration corresponding to carbonic base content in the sample.
viii) performing FTIR analysis on contents of the sealed vessel that holds the mixture of vii) to measure a first absorbance in the predefined spectral band characteristic of active IR salt concentration as well as a second absorbance in the predefined spectral band characteristic of carbon dioxide gas concentration;
ix) calculating data that characterizes concentration of total base content in the sample based on the first absorbance measured in viii) and the first calibration equation derived in iii); and
x) calculating data that characterizes concentration of carbonate base content in the sample based on the second absorbance measured in viii) and the second calibration equation derived in vi).

34. A method according to claim 33, further comprising:
xi) calculating data that characterizes concentration of non-carbonic base content in the sample by subtracting the data that characterizes carbonate base content in the sample from the data that characterizes concentration of total base content in the sample.

35. A method according to claim 33, wherein:
the sample is a hydrophobic fluid sample selected from the group consisting of lubricants, edible oils, and fuels; and/or
the sample comprises a solid matrix.

36. A method according to claim 34, further comprising:
xii) storing the data calculated in ix) and x) for output.

37. A method according to claim 34, further comprising:
xiii) outputting to a user the data stored in xii).

38. A method according to claim 33, wherein:
the reagent includes trifluoroacetic acid.

39. A method according to claim 38, wherein:
the reaction of the trifluoroacetic acid and the total base content produces an IR active salt of trifluoroacetate ions at a concentration corresponding to the concentration of the total base content.

40. A method according to claim 39, wherein:
the predefined spectral band characteristic of active IR salt concentration of trifluoroacetate ions encompasses the range between 1666 cm⁻¹ and 1686 cm⁻¹.

41. A method according to claim 33, wherein:
the predefined spectral band characteristic of carbon dioxide gas concentration encompasses the range between 2330 cm⁻¹ and 2340 cm⁻¹.

42. A method according to claim 33, wherein:
the mixture of vii) is prepared by reacting at least a portion of the sample with the reagent in a sealed vessel.

43. A method according to claim 33, wherein:
the mixture of vii) is prepared by applying an extraction solvent to the sample to produce a liquid-phase extract that carries the predefined component of the sample, and reacting the liquid-phase extract with the reagent in a sealed vessel.
